(19) United States
(12) Patent Application Publication
(10) Pub. No.: US 2025/0371327 A1
(43) Pub. Date: Dec. 4, 2025

(54) HARDWARE EMBEDDED CONTEXTUAL EMBEDDING MODEL

(71) Applicant: Intel Corporation, Santa Clara, CA (US)

(72) Inventors: Yaron Klein, Rosh Haayin (IL); Yuval Vered, Tel-Aviv (IL); Guy Yechezkel Azov, Petach-Tikva (IL); Yoni Elron, Hadera (IL); John Crouter, Fair Oaks, CA (US)

(73) Assignee: Intel Corporation, Santa Clara, CA (US)

(21) Appl. No.: 19/302,713

(22) Filed: Aug. 18, 2025

Related U.S. Application Data
(60) Provisional application No. 63/716,441, filed on Nov. 5, 2024.

(51) Int. Cl. G06N 3/048; G06F 1/03; G06F 7/02; G06F 17/16

(52) U.S. Cl. CPC G06N 3/048; G06F 1/03; G06F 7/02; G06F 17/16

(57) ABSTRACT

An integrated circuit (IC) device may implement a contextual embedding model. The IC device may include a tokenizer unit, embedder unit, layer normalizer unit, dot unit, activator units, and flow control unit. The tokenizer unit may implement a tokenizer in the model and convert text to tokens using the vocabulary of the model. The embedder unit may implement embedders in the model and generate embeddings from the tokens. The layer normalizer unit may implement one or more layer normalizers in the model and compute embedding vectors. The dot unit may implement matrix multiplication and add operations in the encoders and pooler of the model. The activator units may implement activation functions, including tanh function, in the model. The flow control unit may orchestrate the other components of the IC device based on a timing sequence of neural network operations in the model.

### CROSS-REFERENCE TO RELATED APPLICATION

This application claims the benefit of U.S. Provisional Patent Application No. 63/716,441, filed Nov. 5, 2024, and titled “HARDWARE EMBEDDED MODEL AND WEIGHTS FOR CONTEXTUAL EMBEDDING GENERATION,” which is incorporated by reference in its entirety for all purposes.

### TECHNICAL FIELD

This disclosure relates generally to artificial intelligence (AI), and more specifically, hardware embedded contextual embedding models.

### BACKGROUND

Neural networks (also referred to as “deep neural networks” or “DNNs”) are used extensively for a variety of AI applications ranging from natural language processing to computer vision, speech recognition, and image processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG.) 1 illustrates an exemplary contextual embedding model, in accordance with various embodiments.

FIG. 2 illustrates an exemplary encoder of a contextual embedding model, in accordance with various embodiments.

FIG. 3 illustrates an exemplary pooler of a contextual embedding model, in accordance with various embodiments.

FIG. 4 illustrates an integrated circuit (IC) device that implements a contextual embedding model on silicon, in accordance with various embodiments.

FIG. 5 illustrates a tokenizer unit, in accordance with various embodiments.

FIG. 6 illustrates an embedder unit, in accordance with various embodiments.

FIG. 7 illustrates a layer normalizer unit, in accordance with various embodiments.

FIGS. 8A-8C illustrate a Gaussian Error Linear Unit (GELU) unit, in accordance with various embodiments.

FIG. 9 illustrates a SoftMax unit, in accordance with various embodiments.

FIG. 10 illustrates an embedding dot unit, in accordance with various embodiments.

FIG. 11 illustrates a sequential read-only memory, in accordance with various embodiments.

FIGS. 12A-12C illustrate a tanh unit, in accordance with various embodiments.

FIG. 13 illustrates an exemplary transformer model, in accordance with various embodiments.

FIG. 14A illustrates a first inference phase of a transformer model, in accordance with various embodiments.

FIG. 14B illustrates subsequent inference phases of the transformer model, in accordance with various embodiments.

FIG. 15 is a flowchart of a method of executing a contextual embedding model, in accordance with various embodiments.

FIG. 16 is a block diagram of an example computing device, in accordance with various embodiments.

### DETAILED DESCRIPTION

The last decade has witnessed a rapid rise in AI based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more operations, such as matrix multiplication, convolution, activation function, interpolation, layer normalization, batch normalization, SoftMax operation, pooling, elementwise operation, linear operation, nonlinear operation, and so on. These operations are referred to as deep learning operations or neural network operations.

Neural network operations may be tensor operations. Input or output data of neural network operations may be arranged in data structures called tensors. Taking a convolutional layer for example, the input tensors include an activation tensor (also referred to as “input feature map (IFM)” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L-1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

The deployment and execution of many DNNs including complex models are carried out on high-performance graphics processing units (GPUs). While GPUs can provide the computational horsepower needed to handle these sophisticated models, they come with significant drawbacks, including high power consumption and latency issues. These limitations can be especially problematic in environments where real-time processing and power efficiency are critical, such as in mobile devices, edge computing, and Internet of Things (IoT) applications.

A specific challenge arises in generating contextual embeddings. Contextual embeddings may be dense vector representations of text that capture the semantic meaning of words, phrases, or sentences within their specific context. Unlike static embeddings, which assign a single vector to each word regardless of context (e.g., the word “bank” has the same vector representation whether it's used in the context of a financial institution or a river bank), contextual embeddings dynamically adjust based on surrounding words (e.g., the word “bank” would have different vector representations in the sentences “I need to deposit money at the bank” and “The river bank is eroding”). A contextual embedding model is a type of natural language processing (NLP) model that generates word embeddings based on the context in which the words appear. Unlike traditional word embeddings like Word2Vec or GloVe, which assign a fixed vector representation to each word regardless of context, contextual embedding models, such as BERT (Bidirectional Encoder Representations from Transformers) and GPT (Generative Pretrained Transformer), consider the entire context of a word within a sentence to generate its embedding. This allows the model to capture the nuances of language and produce more accurate representations of words, which makes the model crucial for a wide range of NLP tasks, including language modeling, information retrieval, and text classification.

Such embeddings can be used for various applications, including retrieval-augmented generation (RAG). RAG typically involves retrieving relevant documents or pieces of information from a large corpus to enhance the generation of contextually accurate and informative responses. However, these systems often rely on cloud-based servers and high-performance GPUs, which may not be suitable for all use cases due to several inherent limitations.

One problem is latency. Cloud-based solutions typically require data to be sent to and processed by remote servers. This round-trip communication can introduce significant latency, making real-time processing challenging. For applications on edge devices or laptops, such delays can be detrimental to user experience and functionality. There is also a problem with power consumption. High-performance GPUs used in cloud infrastructures typically consume considerable power, which is not ideal for battery-operated devices like mobile phones and laptops that require efficient power management. Another problem is with security and privacy. Transmitting sensitive data to the cloud for processing can raise security and privacy concerns. In many scenarios, especially in industries like healthcare and finance, it's crucial to ensure that data remains secure and private, which is harder to guarantee when data leaves the local device. Furthermore, connectivity can be a challenge. Cloud-based solutions rely on stable internet connections. In situations where connectivity is unreliable or unavailable, such as remote locations or during network outages, cloud-dependent models become inaccessible.

Some solutions are based on GPUs. These solutions involve using a standard GPU where model weights are loaded from memory every time an inference task is performed. While GPUs can offer flexibility, allowing them to handle a wide range of tasks, this comes at the cost of optimization, power consumption, and latency. Additionally, in devices where GPUs are shared resources, their wide range of task capabilities often lead to high utilization, causing potential bottlenecks and further latency.

Some solutions are based on neural processing units (NPUs). NPUs typically are specialized hardware designed explicitly for AI tasks, particularly inference on pretrained models. They are optimized for the types of computations required in deep learning, such as matrix multiplications and convolutions, and can handle large-scale model weights more efficiently than general-purpose hardware. While NPUs are optimized for deep learning tasks, their flexibility in handling a variety of AI workloads can lead to high utilization in devices where they are shared resources. This high utilization can cause bottlenecks, increasing latency and reducing overall efficiency. Moreover, similar to GPUs, NPUs consume significant power, which is a critical factor in battery-operated devices.

Some solutions are based on central processing units (CPUs). CPUs are also used for AI inference tasks by loading the model on them. However, CPUs are not suitable for large-scale matrix multiplications, which are essential for AI inferencing tasks. They also consume more power and are slower in comparison to dedicated solutions. While CPUs offer versatility, their general-purpose nature makes them less efficient for specific tasks like deep learning inference.

Some solutions are based on field programmable gate arrays (FPGAs). FPGAs are programmable hardware that can be customized to perform specific tasks, including loading and handling large language model (LLM) weights. While FPGAs offer flexibility, they have significantly lower performance compared to dedicated hardware solutions and are not as power-efficient and not cost effective.

Some solutions are cloud-based. These solutions can provide APls and services for generating embeddings and performing various NLP tasks. They often rely on cloud infrastructure and high-performance GPUs to process data. However, cloud-based solutions require data to be sent to remote servers, which introduces latency and can be problematic in real-time applications. Additionally, transmitting sensitive data to the cloud raises security and privacy concerns. These solutions also depend on stable internet connectivity, which may not be reliable in all scenarios.

Embodiments of the present disclosure may improve on at least some of the challenges and issues described above by providing hardware embedded contextual embedding models. For instance, the model architecture and weights of a context embedding model are embedded on an IC device, such as a die or chip. The IC device may include various units that implement various operators in the contextual embedding model. The IC device may execute neural network operations in the contextual embedding model with minimal or even no data movement. This disclosure can address the limitations of generating contextual embeddings, particularly concerning the input context size, by leveraging the advanced capabilities of hardware embedded model.

In various embodiments of the present disclosure, a contextual embedding model may include a tokenizer, a word embedder, a position embedder, a token embedder, a layer normalizer, a plurality of encoders, and a pooler. The model may be mapped to an IC device that includes a tokenizer unit, an embedder unit, a layer normalizer unit, a dot unit, activator units, and a flow control unit. The tokenizer unit may be a hardware implementation of the tokenizer in the model. The tokenizer unit may include a comparator that compares text received by the IC device (“input text”) with one or more vocabularies of the model. The tokenizer unit may output one or more token identifiers. The embedder unit may be a hardware implementation of the embedders in the model. The embedder unit may include one or more look-up tables and may convert the token identifier(s) into one or more token embeddings. The layer normalizer unit may perform layer normalization on the token embedding(s) using a weight vector and output an embedding vector. The dot unit may be a hardware implementation of MatMul operations and add operations in the encoders and pooler. The activator units may be hardware implementation of activation functions in the encoders and pooler. The dot unit and activation units may perform operations in the encoders to generate a matrix, then perform operations in the pooler to generate a vector representation of the input text, which may be the output of the model. The flow control unit may orchestrate the other components of the IC device based on a timing sequence of the operations in the model.

This disclosure provides a silicon-based approach that can encapsulate the entire model within a closed, efficient unit, such as the IC device described above. This unit can perform text-to-embedding conversion as a black box. This approach allows users to input text and receive embedding vectors directly on the device, which can then be used for various downstream tasks, such as computing cosine similarity for semantic search or clustering. By embedding the model and weights directly into hardware, this disclosure can boost the performance of contextual performance model inference. For instance, the time and power required to load these weights from memory are eliminated. This can be achieved through the direct integration of model parameters into the silicon, thereby removing the need for data transfer between memory and processing units. Consequently, inference tasks can be executed faster, providing a significant performance boost. Additionally, the optimized compute units in the hardware device can ensure rapid and efficient processing of data, further enhancing performance.

This approach can also improve power efficiency and reduce power consumption by eliminating the need to repeatedly load weights and models from memory for each inference task. This can be accomplished by embedding the model directly onto the chip, which eliminates the need for memory access operations. The use of specialized hardware modules, such as Sequential Read Memory, which powers on the needed next line). And Look-Up Table-based Sigmoid Linear Unit (SiLU) activation and Softplus function, also contributes to lower power usage by offering efficient computational pathways. This can make the approach more power-efficient, reducing the overall operational cost and making it a more environmentally friendly approach.

This approach is cost effective. Unlike general-purpose GPUs or FPGAs, these dedicated chips are specifically designed to handle AI inference tasks. Therefore, they do not carry any overhead of unnecessary or general-purpose functionalities, making the approach more cost effective.

This approach can also provide better scalability and security. Due to the encapsulation of specialized LLM models on multiple chips and the use of a token interface, the system requires low bandwidth per inferencing task into the system on chip (SoC). Multiple SoCs can be connected in parallel to simultaneously handle numerous batches of inference requests with low overhead, enhancing scalability. As the models and weights are hardcoded into the hardware, model integrity is assured and less susceptible to manipulation, enhancing security.

Furthermore, this approach can facilitate real-time computing. The power efficiency and performance boost offered by this approach make it ideal for edge computing, mobile and IoT applications where resources are limited and low latency is required

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

FIG. 1 illustrates an exemplary contextual embedding model 100, in accordance with various embodiments. The contextual embedding model 100 may be used to perform text embedding tasks. For instance, the contextual embedding model 100 may receive words and generate word embeddings based on the context in which the words appear. The contextual embedding model 100 may be BERT, GPT, or other DNNs that can generate contextual embeddings. As shown in FIG. 1, the contextual embedding model 100 includes a tokenizer 110, word embedder 120, position embedder 130, token embedder 140, layer normalizer 150, six encoders 161-166, and pooler 170. Each one of these components may be a layer or part of a layer of the contextual embedding model 100. In other embodiments, the contextual embedding model 100 may include fewer, more, or different components. Also, the arrangement of the components in the contextual embedding model 100 may be different.

In some embodiments, the contextual embedding model 100 may receive an input. The input may be text data. For instance, the input may include one or more words. The tokenizer 110 may convert words into token indices. A token index may be an identifier (ID) of a token in a vocabulary of the contextual embedding model 100. Every token in the vocabulary may have its unique ID. The contextual embedding model 100 may have one or more vocabularies, each of which include a plurality of tokens. In an example, the contextual embedding model 100 may have a vocabulary of 30,522 tokens. Each of these tokens may have a token ID, indicating the index of the token in the vocabulary. The tokenizer 110 may determine one or more token indices based on the input text and the one or more vocabularies of the contextual embedding model 100.

The output of the tokenizer 110 is provided to an embedder subsystem in the contextual embedding model 100. The embedder subsystem converts the tokens to embeddings. For instance, the embedder subsystem may transform tokens into dense vectors and sum the dense vectors to form input embeddings. In the example shown in FIG. 1, the embedder subsystem includes the word embedder 120, position embedder 130, and token embedder 140. In other embodiments, the embedder subsystem may include fewer, more, or different embedders. The word embedder 120 may convert the output of the tokenizer 110 to word embeddings. For instance, the word embedder 120 may apply a weight vector 101 on the token(s) and compute word embeddings. The word embeddings may be arranged in a tensor, which is the output tensor of the word embedder 120. In an example, a token may be a 15-bit integer, the weight vector 101 may have a length of 384 (e.g., the weight vector 101 has 384 weights), and the output tensor of the word embedder 120 may be a matrix (such as a 512×384 matrxi).

The output tensor of the word embedder 120 is provided to the position embedder 130. The position embedder 130 may generate position embeddings from the word embeddings. The position embedder 130 may apply a weight vector 102 on the output tensor of the word embedder 120 and produce position embeddings. The position embeddings may be arranged in a tensor, which is the output tensor of the position embedder 130. In an example, the weight vector 102 may have a length of 384 (e.g., the weight vector 101 has 384 weights), and the output tensor of the position embedder 130 may be a matrix (such as a 2×384 matrxi).

The output tensor of the position embedder 130 is then provided to the token embedder 140. The token embedder 140 may generate token embeddings from the position embeddings. The token embedder 140 may apply a weight vector 103 on the output tensor of the position embedder 130 and produce token embeddings. The token embeddings may be arranged in a tensor, which is the output tensor of the token embedder 140. In an example, the weight vector 103 may have a length of 384 (e.g., the weight vector 101 has 384 weights), and the output tensor of the token embedder 140 may be a vector, such as a vector with 384 elements.

The layer normalizer 150 receives the output tensor of the token embedder 140. The layer normalizer 150 also receives a weight vector 104 and performs one or more layer normalization operations on the output tensor of the token embedder 140 and the weight vector 104. The layer normalizer 150 may normalize the inputs (e.g., the token embeddings) across the features for each data point independently. In some embodiments, a layer normalization operation performed in the layer normalizer 150 may be denoted as

$$y = \frac{x - E [ x ]}{\sqrt{Var ( x ) + ϵ}} \times γ + β ,$$

where γ and β are the weights, x is the input, E[x] is the mean of the input, Var(x) is the variance of the input, ε is a constant value added for numerical stability, and y is the output. The layer normalizer 150 may apply the weight vector 104 on an input vector from the token embedder 140 to compute a new vector. The new vector may have the same dimension as the input vector. The output tensor of the layer normalizer 150 may be a matrix. In an example, the matrix's spatial shape may be 384×512. The layer normalizer 150 can ensure stability in the learning process by normalizing the embeddings before they enter the encoders 161-166.

The weight vector 101, weight vector 102, weight vector 103, or weight vector 104 may be denoted as Wₙ. In some embodiments, the weight vector 101, weight vector 102, weight vector 103, or weight vector 104 may have a floating-point data format, such as FP16. In other embodiments, the weight vector 101, weight vector 102, weight vector 103, or weight vector 104 may have other data formats. In some embodiments, the weight vector 101, weight vector 102, weight vector 103, and weight vector 104 may have different data formats from each other.

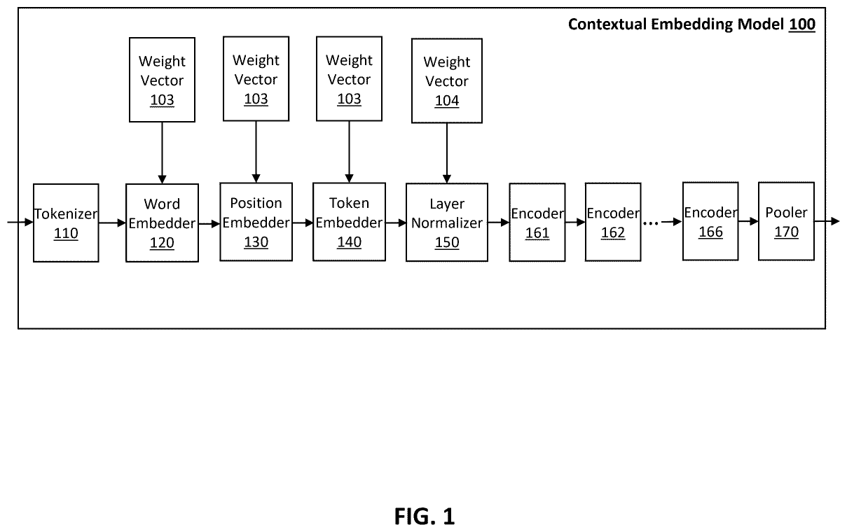

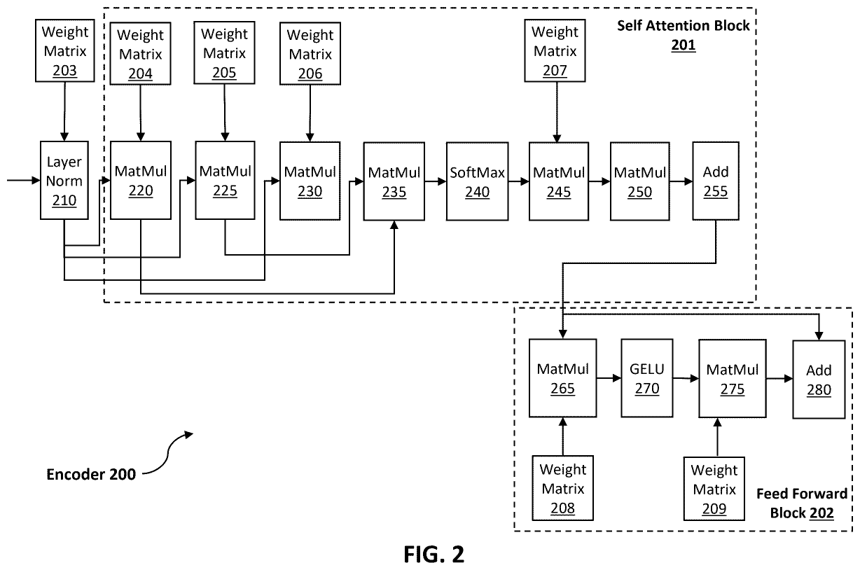

The output tensor of the layer normalizer 150 is further processed in the encoders 161-166. Each encoder may be a layer. In some embodiments, an encoder may be referred to as a transformer layer or encoder layer. Even though FIG. 1 shows six encoders, the contextual embedding model 100 may have fewer or more encoders in other embodiments. Each of the encoders 161-166 may include a sequence of operations through which an input tensor is processed to compute an output tensor. In an example, the spatial shape of the input tensor or output tensor of an encoder may be 384×512. In some embodiments, the encoders 161-166 may use self-attention mechanisms and feed forward neural networks to process and refine embeddings. Certain aspects of the encoders 161-166 are described below in conjunction with FIG. 2.

The output tensor of the encoder 166 is provided to the pooler 170 where one or more pooling operations are performed. In some embodiments, the pooler 170 may extract a fixed-size vector (e.g., a vector of 512 elements) from the encoder output, e.g., from the classification ([CLS]) token, for downstream tasks. The output of the pooler 170 may be contextual embeddings, which may be the final output of the contextual embedding model 100. Certain aspects of the pooler 170 are described below in conjunction with FIG. 2.

The intricate design of the contextual embedding model 100 can seamlessly integrate various neural network operations to provide context-aware representations of input text. The contextual embedding model 100 may be used to perform various AI tasks, such as NLP tasks. The contextual embedding model 100 may facilitate various data types. In an example, data in the contextual embedding model 100 may have a floating-point data format, such as FP16, BF16, FP32, and so on. As another example, data in the contextual embedding model 100 may have an integer format, such as INT5, INT8, INT9, and so on.

FIG. 2 illustrates an exemplary encoder 200 of a contextual embedding model, in accordance with various embodiments. The encoder 200 can efficiently process input embeddings through a series of highly optimized neural network operations. The encoder 200 may be an example of the encoders 161-166 in FIG. 1. As shown in FIG. 2, the encoder 200 includes a layer normalizer 210 (shown as “layer norm” in FIG. 2), MatMul operator 220, MatMul operator 225, MatMul operator 230, MatMul operator 235, SoftMax activator 240, MatMul operator 245, MatMul operator 250, add operator 255, MatMul operator 265, GELU activator 270, MatMul operator 275, and add operator 280. For the purpose of illustration, MatMul operator is shown as “MatMul” in FIG. 2, add operator is shown as “add” in FIG. 2, SoftMax activator is shown as “SoftMax” in FIG. 2, and GELU activator is shown as “GELU” in FIG. 2. In other embodiments, the encoder 200 may include fewer, more, or different components. Also, the arrangement of the components in the encoder 200 may be different.

The layer normalizer 210 can standardize input data, such as input embeddings. The layer normalizer 210 may perform a layer normalization on an input to the encoder 200 and a weight matrix 203. The weight matrix 203 may include two weight vectors. In an example, the spatial size of the input may be 128,256, and the spatial size of the weight matrix 203 may be 1,024×2. The layer normalization may be denoted as

$$y = \frac{x - E [ x ]}{\sqrt{Var ( x ) + ϵ}} \times γ + β ,$$

where γ and β are the weights, x is the input, E[x] is the mean of the input, Var(x) is the variance of the input, ε is a constant value added for numerical stability, and y is the output. In some embodiments, the weight matrix 203 may be a matrix of root mean square (RMS) attention weights. The layer normalization may be RMS normalization, which can normalize input data elements of the encoder 200 based on the RMS of the activations. The normalization may stabilize the inputs and ensure that the attention weights can be computed on approximately scaled inputs, leading to better training stability and faster convergence. The output of the layer normalizer 210 may be one or more tokens. A token may be represented by a 15-bit integer.

At least some of the MatMul operator 220, MatMul operator 225, MatMul operator 230, MatMul operator 235, MatMul operator 245, MatMul operator 250, MatMul operator 265, and MatMul operator 275 can handle the transformation and integration of embedding vectors across different layers. As shown in FIG. 2, the output of the layer normalizer 210 is provided to the MatMul operator 220. The MatMul operator 220 performs MatMul on the output of the layer normalizer 210 and a weight matrix 204. The weight matrix 204 may be a matrix of query weights, which may be denoted as W_{Q}. The MatMul result is provided to the MatMul operator 235. The output of the layer normalizer 210 is also provided to the MatMul operator 225. The MatMul operator 225 performs MatMul on the output of the layer normalizer 210 and a weight matrix 205. The weight matrix 205 may be a matrix of key weights, which may be denoted as W_{K}. The MatMul result is provided to the MatMul operator 235. The output of the layer normalizer 210 is further provided to the MatMul operator 230. The MatMul operator 230 performs MatMul on the output of the layer normalizer 210 and a weight matrix 206. The weight matrix 206 may be a matrix of value weights, which may be denoted as W_{V}. In an example, the spatial size of the weight matrix 204, 205, or 206 may be 4,096×4,096. The output of the layer normalizer 210 may be represented by a vector, the length of which may be 4,096. The output of the MatMul operator 220, 225, or 230 may be a vector with a length of 4,096.

The MatMul operator 235 may perform a matrix multiplication on the output of the MatMul operator 220 and the output of the MatMul operator 225 and produce a vector. The vector is then provided to the SoftMax activator 240. The SoftMax activator 240 may apply a SoftMax activation function on the vector. The result of the SoftMax activation function is provided to the MatMul operator 245 for performing another MatMul. The output of the MatMul operator 245, which may be a vector having a length of 4,096, and a weight matrix 207, which may have a spatial size of 4,096×4096 and may be denoted as W_{O}, may be provided to the MatMul operator 250. The MatMul operator 250 may perform a MatMul and produce a vector, the length of which may be 4,096.

The MatMul operator 220, MatMul operator 225, MatMul operator 230, MatMul operator 235, SoftMax activator 240, MatMul operator 245, and MatMul operator 250 constitute a self-attention block 201 of the encoder 200. In the example described above, a 4,096 embedding vector may be split to 16 heads sized 128 each. The self-attention mechanism, utilizing SoftMax function(s), can enable the model to focus on relevant parts of the input sequence, enhancing the accuracy of contextual embedding generation.

The output of the self-attention block 201, which may be a vector having a length of 4,096, is provided to the add operator 255, which may perform an elementwise addition on the output of the self-attention block 201 and input of the encoder 200 and produce a vector, the length of which may be 4,096. The vector is provided to the MatMul operator 265, which may perform a MatMul on the vector and a weight matrix 208. The weight matrix 208 may be denoted as W₁. In an example, the spatial size of the weight matrix 208 is 1,024×4,096. The output of the MatMul operator 265 may be a vector having a length of 4,096. The output of the MatMul operator 265 is provided to the GELU activator 270, which applies a GELU activation function on the output of the MatMul operator 265. The output of the GELU activator 270 may be a vector whose dimension may be 4,096. The vector is provided to the MatMul operator 275, which performs MatMul on the vector and a weight matrix 209. The weight matrix 209 may be denoted as W₂. In an example, the spatial size of the weight matrix 209 is 1,024×4,096. The MatMul operator 275 produces a vector, the dimension of which may be 1,024. The vector is provided to the add operator 280, which performs an elementwise addition on the vector and the output of the add operator 255 and produces a new vector, the dimension of which may be 1,024. The new vector may be the output of the encoder 200.

The MatMul operator 265, GELU activator 270, and MatMul operator 275 constitutes a feed forward block 202 of the encoder 200. The feed forward block 202 may also be referred to as a feed forward DNN. The feed forward block 202 can ensure rapid and effective data processing.

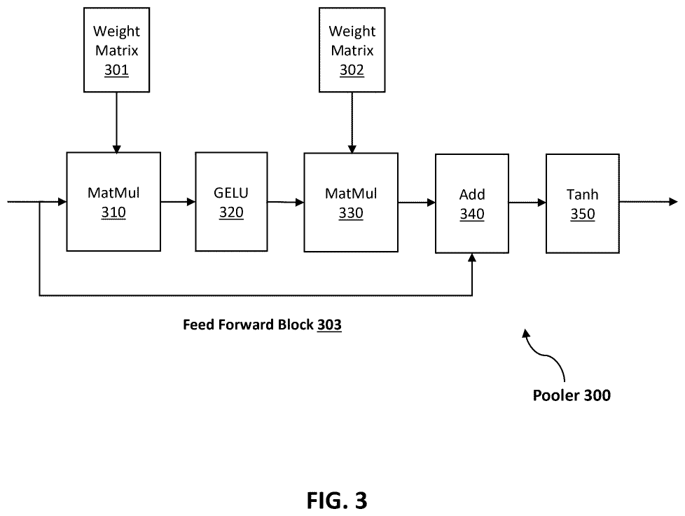

FIG. 3 illustrates an exemplary pooler 300 of a contextual embedding model, in accordance with various embodiments. The pooler 300 can processes the output of the transformer layers to generate a fixed-size representation for the entire input sequence. For instance, the pooler 300 extracts the hidden state corresponding to the [CLS] token, which is used as a summary of the input sequence. This pooled representation can be used for classification tasks or other downstream applications where a fixed-size vector is needed. The pooler 300 may be an example of the pooler 170 in FIG. 1. As shown in FIG. 3, the pooler 300 includes a MatMul operator 310, GELU activator 320, MatMul operator 330, add operator 340, and a tanh activator 350.

The MatMul operator 310 (shown as “MatMul” in FIG. 3) may receive a vector, which may be [CLS] token(s). This vector may be an input vector of the pooler 300. The elements of the vector may also be referred to as activations. The MatMul operator 310 may apply a MatMul operation on the vector using a weight matrix 301. In some embodiments, the MatMul operation is a binary operation that produces a matrix from two matrices. The number of columns in the first matrix may be equal to the number of rows in the second matrix. The resulting matrix, known as the matrix product, has the number of rows of the first matrix and the number of columns of the second matrix. The first matrix may be the input vector, the second matrix may be the weight matrix 301, or vice versa. The weight matrix 302 may be denoted as W₁. The output of the MatMul operator 310 may be a vector. In an example, the size of the input vector is 384, the size of the weight matrix 301 is 384×384, and the size of the output vector is 384.

The output of the MatMul operator 310 is provided to the GELU activator 320, which applies a GELU activation function on the output of the MatMul operator 310. The GELU activation function may be denoted as f(x)=0.5x[1+erf(x/\sqrt{2})], where x is the input to the GELU activator 320. The output of the GELU activator 320 may be a vector whose dimension may be 384. The vector is provided to the MatMul operator 330, which performs MatMul on the vector and a weight matrix 302. The weight matrix 302 may be denoted as W₂. In an example, the spatial size of the weight matrix 302 is 384×384. The MatMul operator 330 produces a vector, the dimension of which may be 384. The vector is provided to the add operator 340, which performs an elementwise addition on the vector a bias vector and produces a new vector, the dimension of which may be 384. The MatMul operator 310, GELU activator 320, and MatMul operator 330 constitutes a feed forward block 303 of the pooler 300. The vector computed in the add operator 340 is the output of the feed forward block 303. The feed forward block 303 may also be referred to as a feed forward DNN.

The output of the feed forward block 303 is then provided to the tanh activator 350. The tanh activator 350 may apply a tanh activation function on the vector computed in the add operator 340. The tanh activation function may be denoted as

$$tanh ( x ) = \frac{{e}^{x} - {e}^{- x}}{{e}^{x} + {e}^{- x}} ,$$

where x is the input to the tanh activator 350. The tanh activator 350 produces a new vector, which is the output of the pooler 300. This sequence of operations in the pooler 300 can convert the [CLS] token embedding into a fixed-size, context-aware vector, making it suitable for downstream tasks such as classification.

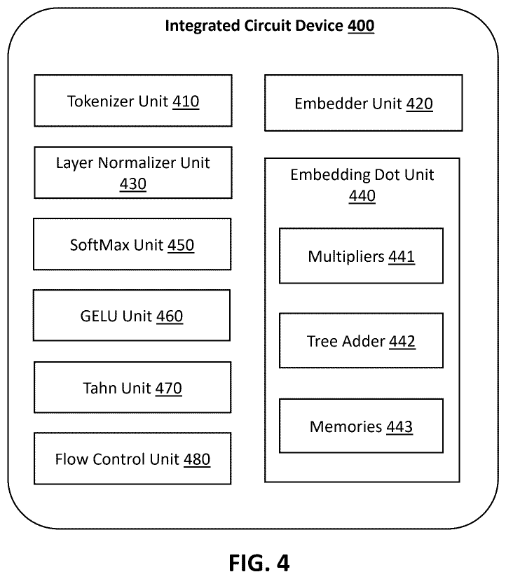

FIG. 4 illustrates an IC device 400 that implements a contextual embedding model on silicon, in accordance with various embodiments. The IC device 400 may embed inference of the contextual embedding model. The IC device 400 can provide and implement at least a part of the contextual embedding model in a single die or a single chip. The entire architecture, weights, and flow of the contextual embedding model can be embedded into the IC device 400. An example of the contextual embedding model is the contextual embedding model 100 in FIG. 1.

As shown in FIG. 4, the IC device 400 includes a tokenizer unit 410, embedder unit 420, layer normalizer unit 430, an embedding dot unit 440, SoftMax unit 450, GELU unit 460, tanh unit 470, and flow control unit 480. A unit in the IC device 400 may be a circuit or may include multiple circuits. In other embodiments, the IC device 400 may include fewer, more, or different components. For instance, the IC device 400 may include more than one tokenizer unit 410, embedder unit 420, layer normalizer unit 430, an embedding dot unit 440, SoftMax unit 450, GELU unit 460, tanh unit 470, or flow control unit 480. Further, functionality attributed to a component of IC device 400 may be accomplished by a different component included in the IC device 400 or a different device.

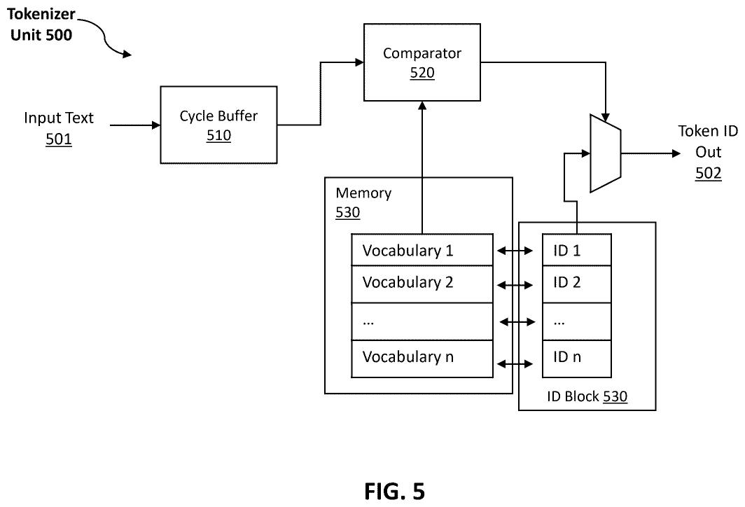

The tokenizer unit 410 is a hardware implementation of a tokenizer in the contextual embedding model. An example of the tokenizer is the tokenizer 110 in FIG. 1. In some embodiments, the vocabulary of the contextual embedding model may be implemented on the tokenizer unit 410. For instance, the vocabulary may be stored in a data storage unit of the tokenizer unit 410. The tokenizer unit 410, after receiving words, may compare the words with the vocabulary to determine indices of tokens corresponding to the words. The tokenizer unit 410 may output the token indices. Certain aspects of the tokenizer unit 410 are described below in conjunction with FIG. 5.

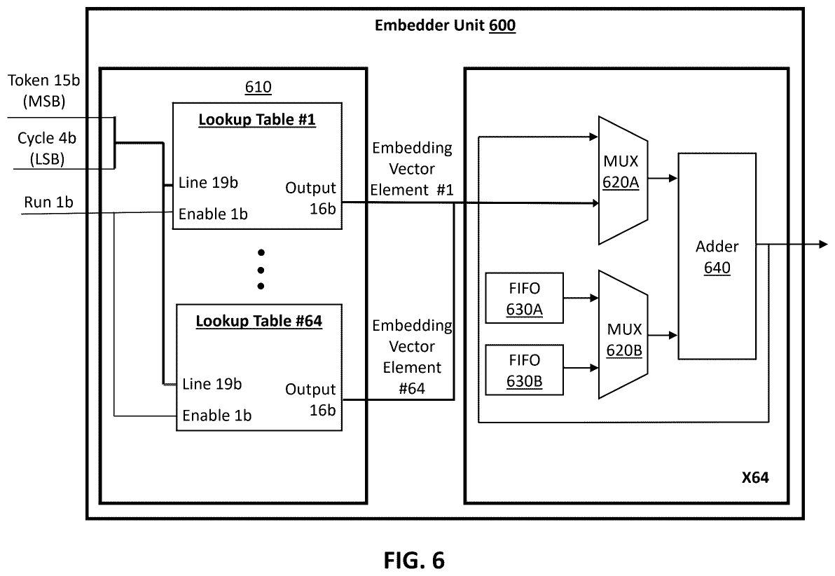

The embedder unit 420 is a hardware implementation of one or more embedders in the contextual embedding model. In some embodiments, the embedder unit 420 implements an embedder subsystem of the contextual embedder system. For instance, the embedder unit 420 may implement the word embedder 120, position embedder 130, and token embedder 140 in FIG. 1. The embedder unit 420 may convert tokens from the tokenizer unit 410 to embeddings, such as token embeddings. In some embodiments, the embedder unit 420 may include look-up tables that map vocabulary of the contextual embedding model to embedding elements. The look-up tables may output embedding elements corresponding to the input tokens. The embedding elements may constitute the embedding vector of the input tokens. Certain aspects of the embedder unit 420 are described below in conjunction with FIG. 6.

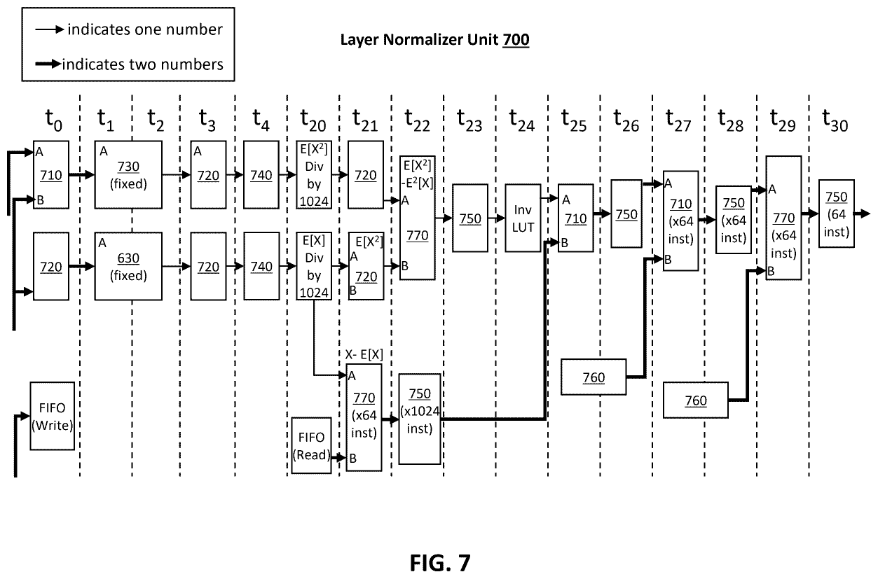

The layer normalizer unit 430 is a hardware implementation of one or more layer normalizers in the contextual embedding model, such as the layer normalizer 150 in FIG. 1 and layer normalizer 210 in FIG. 2. The layer normalizer unit 430 may include one or more multipliers, adders (e.g., tree adders), data converters (e.g., fixed-to-float converter or float-to-fixed converter), other compute units, or some combination thereof. The layer normalizer 150 may include or be coupled with sequential read memories (e.g., sequence read-only memories (ROMs)) that store weights to be used by the layer normalizer unit 430 to perform layer normalization. Certain aspects of the layer normalizer unit 430 are described below in conjunction with FIG. 7.

The embedding dot unit 440 is a hardware implementation of MatMul operators and add operators in the contextual embedding model, such as the MatMul operators and add operators in the encoders of the contextual embedding model as well as the MatMul operators and add operators in the pooler of the contextual embedding model. For instance, the embedding dot unit 440 may implement some or all of the MatMul operator 220, MatMul operator 225, MatMul operator 230, MatMul operator 235, MatMul operator 245, MatMul operator 250, add operator 255, MatMul operator 265, MatMul operator 275, and add operator 280 in FIG. 2. The embedding dot unit 440 may also implement some or all of the MatMul operator 310, MatMul operator 330, and add operator 340 in FIG. 3.

As shown in FIG. 4, the embedding dot unit 440 includes multipliers 441, a tree adder 442, and memories 443. In other embodiments, the embedding dot unit 440 may include fewer, more, or different components. For example, the embedding dot unit 440 may include a single multiplier or memory. As another example, the embedding dot unit 440 may include multiple tree adders. The multipliers 441 may MatMul operations, such as the MatMul operations described above. A multiplier may multiple two values, such as two floating-point values. The two values may have different data formats or precisions. For example, the embedding dot unit 440 may include one or more FP4/FP6 multipliers, one or more FP4/FP8 multipliers, or one or more FP6/FP8 multipliers. One or more multipliers in the embedding dot unit 440 may be specifically designed to perform multiplication of values or data having predetermined representations (e.g., FP4, FP6, FP8, FP12, INT8, etc.). The tree adder 442 includes adders arranged in a tree structure. The tree structure may include a plurality of tiers or levels. The tree adder 442 may implement add operations, such as the add operations described above. The tree adder 442 may also be referred to as an adder tree. In one implementation, the embedding dot unit 440 may use the 441 to carry out a (4096-elements) dot product operation between FP8 embedding vector and FP6 weights vector. The dot product operation can be performed using the multipliers 441 and tree adder 442.

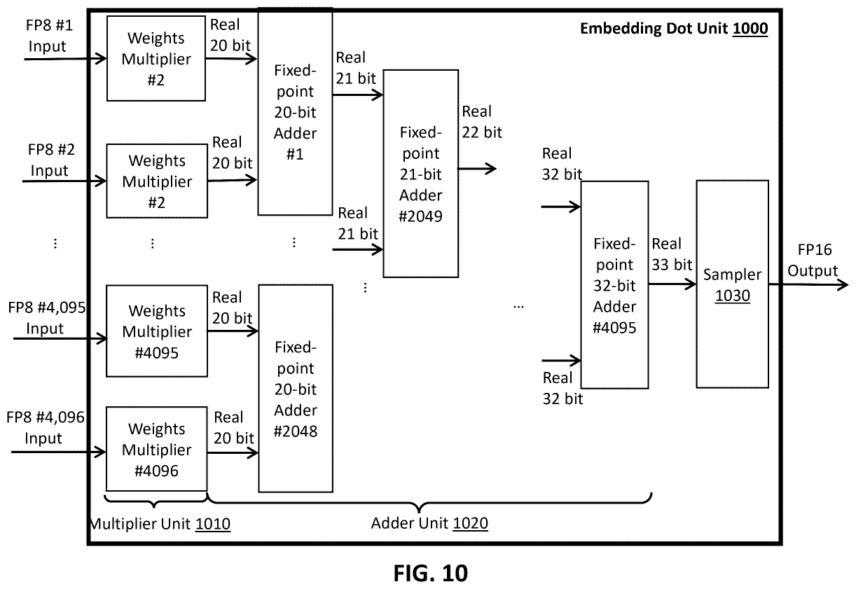

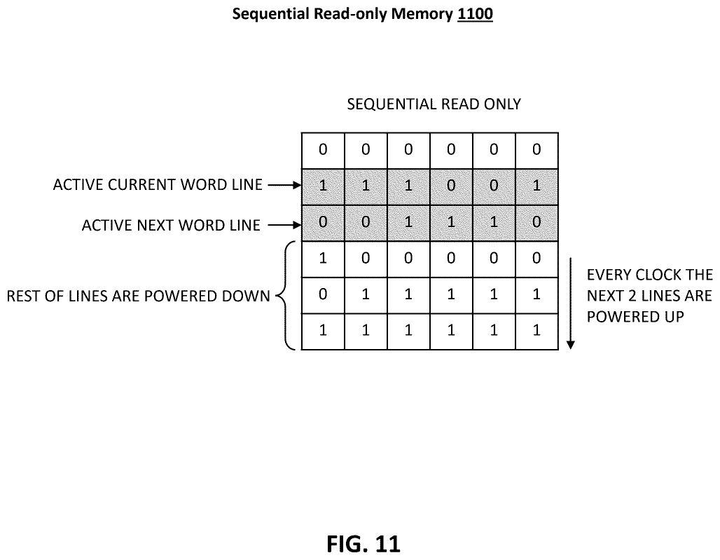

The memories 443 may store and provide data (e.g., weight vector) to the multipliers 441 or tree adder 442. In some embodiments, the memories 443 may be dynamic random access memories (DRAMs). In other embodiments, the memories 443 may be ROMs, such as sequential read-only memories. The memories 443 may be placed in proximity to the components performing logic operations in the embedding dot unit 440, such as multipliers 441. Each multiplier may be coupled with and proximate to a corresponding memory and may receive data (e.g., one or more weights) from the memory. As data is located where it is needed, the embedding dot unit 440 can be very efficient. One or more tree adders may add multiplication results produced by one or more multipliers together. Certain aspects of the embedding dot unit 440 are described below in conjunction with FIG. 10. Certain aspects of the memories 443 are described below in conjunction with FIG. 11.

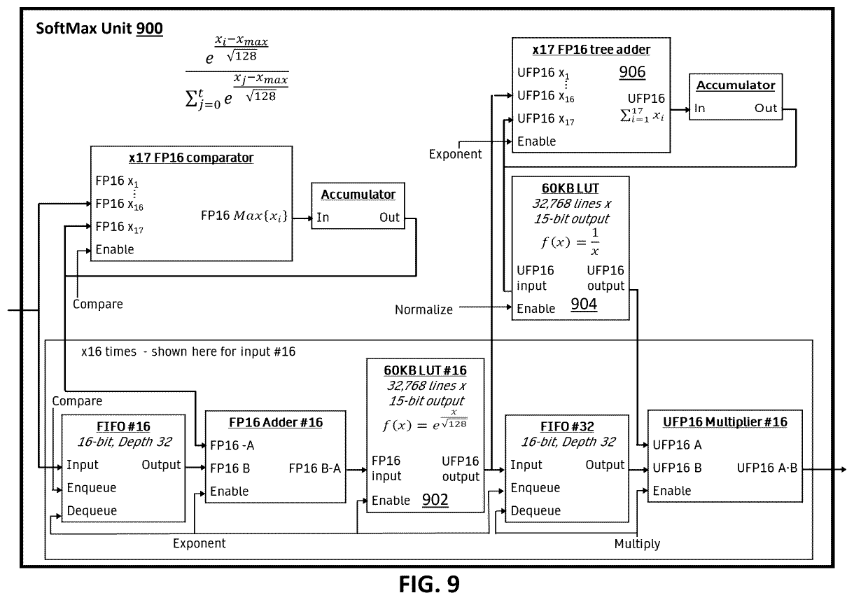

The SoftMax unit 450 is a hardware implementation of one or more SoftMax activators in the contextual embedding model. For instance, the SoftMax unit 450 may implement the SoftMax activator 240 in FIG. 2. The SoftMax unit 450 may execute a SoftMax function using one or more look-up tables that are preconfigured with precomputed data. Certain aspects of the SoftMax unit 450 are described below in conjunction with FIG. 9.

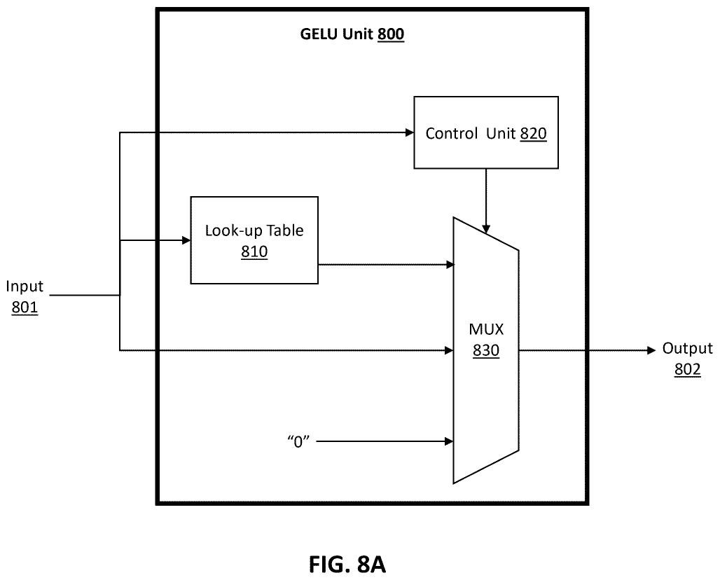

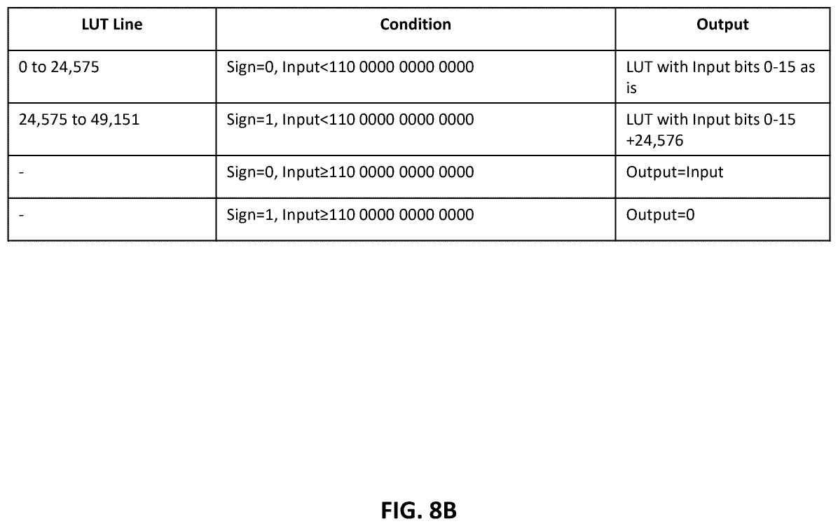

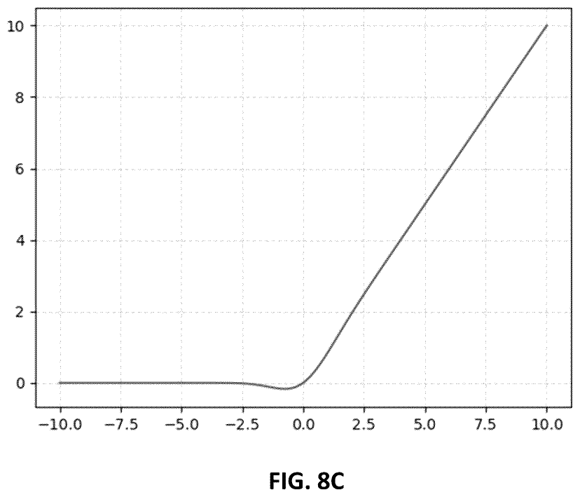

The GELU unit 460 is a hardware implementation of one or more GELU activators in the contextual embedding model. For instance, the GELU unit 460 may implement the GELU activator 270 in FIG. 2 and the GELU activator 320 in FIG. 3. The GELU unit 460 may execute a GELU activation function using one or more look-up tables that are preconfigured with precomputed data. Certain aspects of the GELU unit 460 are described below in conjunction with FIGS. 8A-8C.

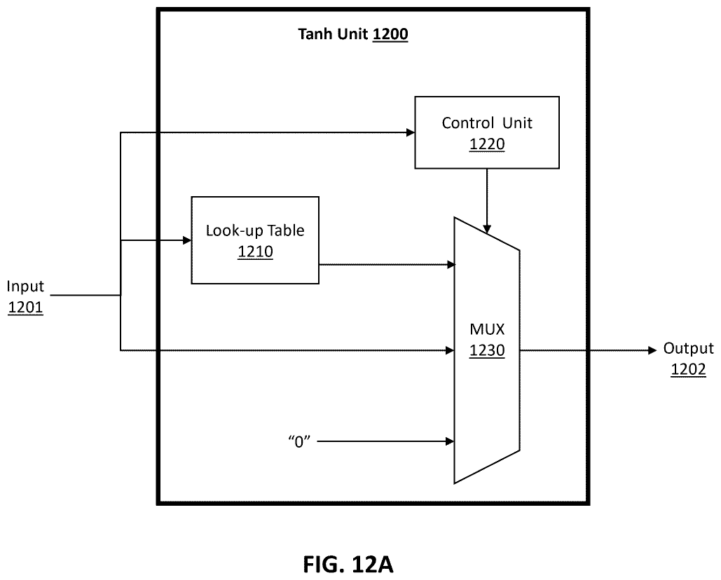

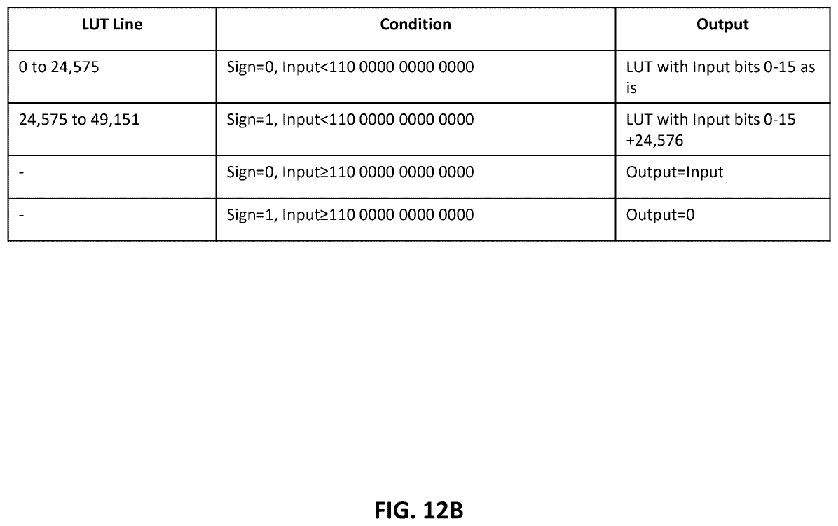

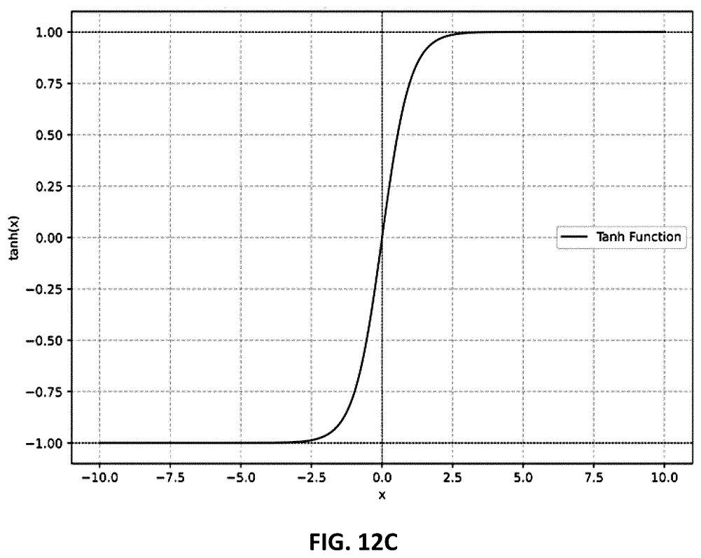

The tanh unit 470 is a hardware implementation of one or more tanh activators in the contextual embedding model. For instance, the GELU unit 460 may implement the tanh activator 350 in FIG. 3. The tanh unit 470 may execute a tanh activation function using one or more look-up tables that are preconfigured with precomputed data. Certain aspects of the tanh unit 470 are described below in conjunction with FIGS. 12A-12C.

The flow control unit 480 plays a role in orchestrating various circuits to execute operations according to a predetermined timing sequence. The flow control unit 480 may also be referred to as a sequencer unit, which can orchestrate one or more other components of the IC device 400 according to a predetermined timing sequence of the contextual embedding model. The contextual embedding model may operate in a feedforward manner for inference. The sequence of operations of the model corresponding to different layers of the neural network can be determined and mapped into a timing sequence of neural network operations, including tokenization, embedding generation, layer normalization, MatMul operation, activation function, and so on. The timing sequence of neural network operations may include stages of operations, one following another. In a particular time slot or stage in the timing sequence, data can be moved in, processed, and moved out to be processed in the next/following time slot, in a feedforward, progressive manner. The flow control unit 480 may implement digital logic to generate clock edges/signals (e.g., control signals, timing signals, enable signals, disable signals, trigger signals, etc.) to orchestrate operations to be performed according to the timing sequence. The flow control unit 480 may control data flow into or out of one or more other components of the IC device 400. For instance, the flow control unit 480 may control the data flow so that it matches the data flow within the contextual embedding model, such as the data flow shown in FIGS. 1-3. The flow control unit 480 may also enable or disable one or more other components of the IC device 400 according to a predetermined timing sequence.

FIG. 5 illustrates a tokenizer unit 500, in accordance with various embodiments. The tokenizer unit 500 is a hardware-based tokenizer for an LLM. The tokenizer unit 500 may be an example of the tokenizer unit 410 in FIG. 4. As shown in FIG. 5, the tokenizer unit 500 includes a cycle buffer 510, comparator 520, memory 530, ID block 540, and multiplexer (MUX) 550. In other embodiments, the tokenizer unit 500 may include fewer, more, or different components.

The cycle buffer 510 receives and stores data received by the tokenizer unit 500. The data is also referred to as input data. The input data may be one or more words that need to be tokenized. In some embodiments, the tokenizer unit 500 may have a different type of data storage unit from the cycle buffer 510 for storing input data.

The comparator 520 retrieves input data from the cycle buffer 510 and compares the word(s) with a vocabulary of the contextual embedding model. The vocabulary may be predefined vocabulary. The memory 530 stores the vocabulary of the contextual embedding model. The memory 530 may be a ROM, such as a sequential read-only memory. The memory 530 may store a list of vocabulary entries, which are predefined words or tokens. Each vocabulary entry corresponding to a unique Token ID. The ID block 540 stores the Token IDs associated with each vocabulary entry. When the comparator 520 finds a match in the vocabulary, the ID block 540 receives the corresponding Token ID. For the purpose of illustration, FIG. 5 shows n vocabulary entries that are associated with n Token IDs, respectively. After a Token ID is retrieved, it is output through the ID block 540.

The comparator 520 may access the vocabulary in the memory 530 to find a match for each word in the input data. When a match is found, the corresponding Token ID is fetched from the ID block 540 and provided to the MUX 550. The MUX 550 may output the Token ID as an output of the tokenizer unit 500. In some embodiments, the output of the Token ID from the MUX 550 may be controlled by a signal from the comparator 520. The signal may indicate that a match has been found.

FIG. 6 illustrates an embedder unit 600, in accordance with various embodiments. The embedder unit 600 may execute embedders of a contextual embedding model during inference of the contextual embedding model. The embedder unit 600 may be an example of the embedder unit 420 in FIG. 4. As shown in FIG. 6, the embedder unit 600 includes 64 look-up tables 610, individually referred to as look-up table 610. In other embodiments, the embedder unit 600 may include a different number of look-up tables. The look-up tables 610 may have the same storage size, e.g., 1000 KB. In an example, each look-up table 610 has 612,000 lines. In some embodiments, the look-up tables 610 may be implemented on one or more ROMs. In an example, the 64 look-up tables 610 are implemented on 64 ROMs, respectively.

The embedder unit 600 may receive an input token. In the example shown in FIG. 6, the embedder unit 600 receives an input token represented by 15 bits. The input token may have an integer format. The embedder unit 600 may also receive control signals. For instance, the embedder unit 600 receives an embedder cycle signal (shown as “cycle” in FIG. 6), which may have 4 bits. The embedder unit 600 also receives an embedder run signal (shown as “run” in FIG. 6), which may have 1 bit. Even though not shown in FIG. 6, the embedder unit 600 may also receive an embedder on/off signal, which may have 1 bit.

The output of a look-up table 610 is an embedding vector of the input token. In some embodiments, an embedding vector may include floating-point (e.g., FP16) data elements. The dimension of the embedding vector may indicate the total number of data elements in the embedding vector. In an example, the dimension of the embedding vector may be 4,096. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. As shown in FIG. 6, within each cycle, the 64 look-up tables may output 64 embedding vector elements, respectively. The embedder unit 600 may return 64 elements every clock cycle for 16 clocks cycles. After finishing the 16 cycles, the embedder unit 600 may be idle for about 10,000 cycles. Power gating may be used.

In an embodiment where the embedder unit 600 implements a word embedder (e.g., the word embedder 120 in FIG. 1), the embedding vectors from the look-up tables 610 may be output from the embedder unit 600 through the MUX 620A and adder 640. In an embodiment where the embedder unit 600 implements a position embedder (e.g., the position embedder 130 in FIG. 1), the embedding vectors from the look-up tables 610 may be accumulated with positional embeddings stored in a first-in-first-out buffer, i.e., FIFO 630A, by the adder 640. The adder 640 may receive the embedding vectors from the MUX 620A and receive the positional embeddings from the MUX 620B. The combined embeddings produced by the adder 640 may be output from the embedder unit 600 as position embeddings to be further processed. In an embodiment where the embedder unit 600 implements a token embedder (e.g., the token embedder 140 in FIG. 1), the embedding vectors from the look-up tables 610 may be accumulated with token-type embeddings stored in a FIFO 630B by the adder 640. The adder 640 may receive the embedding vectors from the MUX 620A and receive the token-type embeddings from the MUX 620B. The combined embeddings produced by the adder 640 may be output from the embedder unit 600 as token embeddings to be further processed.

In some embodiments, the MUX 620B may select data from the FIFO 630A or FIFO 630B to provide to the adder 640. The operation of the MUX 620B may be controlled by the flow control unit 480. In some embodiments, the MUX 620A, MUX 620B, FIFO 630A, FIFO 630B, and adder 640 may constitute a block in the embedder unit 600. The embedder unit 600 may include 64 such blocks. Combined embeddings generated by the embedder unit 600 may provide a comprehensive representation of each token for further processing in the contextual embedding model.

FIG. 7 illustrates a layer normalizer unit 700, in accordance with various embodiments. The layer normalizer unit 700 may execute one or more layer normalizers of a contextual embedding model during inference of the contextual embedding model. Examples of the layer normalizers may include the layer normalizer 150 in FIG. 1 and the layer normalizer 210 in FIG. 2. The layer normalizer unit 700 may be an example of the layer normalizer unit 430 in FIG. 4.

In some embodiments, the layer normalizer unit 700 may perform layer normalization to standardize inputs to a layer, improving training stability and performance. The layer normalizer unit 700 may perform layer normalization by executing a series of mathematical operations on input data, converting between floating-point and fixed-point formats as needed. Layer normalization can improve training stability and performance. In some embodiments, layer normalization may be denoted as:

$$LayerNorm ( x ) = \frac{x - \frac{{\sum }_{j = 0}^{1024} {x}_{j}}{1024}}{\sqrt{\frac{{\sum }_{j = 0}^{1024} {x}_{j}^{2}}{1024} - {( \frac{{\sum }_{j = 0}^{1024} {x}_{j}}{1024} )}^{2} + {10}^{- 5}}} γ + β ,$$

where LayerNorm is layer normalization operation, x is the input vector, xⱼ is an input element with index j, γ is a weight, and β is another weight. In some embodiments,

$$\frac{{\sum }_{j = 0}^{1024} {x}_{j}}{1024}$$

may be the mean of the input vector,

$$\frac{{\sum }_{j = 0}^{1024} {x}_{j}^{2}}{1024} - {( \frac{{\sum }_{j = 0}^{1024} {x}_{j}}{1024} )}^{2}$$

may be the variance, and 10⁻⁵ is a constant used for numerical stability.

The layer normalizer unit 700 includes float-fixed multipliers 710 (individual referred to as “float-fixed multiplier 710”), float-fixed converters 720 (individual referred to as “float-fixed converter 720”), tree adders 730 (individual referred to as “tree adder 730”), accumulators 740 (individual referred to as “accumulator 740”), fixed-float converters 750 (individual referred to as “fixed-float converter 750”), sequential read-only memories 760 (individual referred to as “sequential read-only memory 760”), and fixed-fixed adders 770 (individual referred to as “fixed-fixed adder 770”). A float-fixed multiplier 710 can multiply a floating-point number with a fixed number. A float-fixed converter 720 can convert a floating-point number to a fixed number. A fixed-float converter 750 can convert a fixed number to a floating-point number. A fixed-fixed adder 770 can add a fixed number and another fixed number. In some embodiments, a floating-point number computed or received by a component of the layer normalizer unit 700 may be a FP16 number. The layer normalizer unit 700 also includes FIFOs for write and read.

In some embodiments, the layer normalizer unit 700 multiplies, accumulates, and processes the data through a sequence of adders, multipliers, and look-up tables, as shown in FIG. 7. It also incorporates FIFO buffers and ROMs for data storage and retrieval, ensuring efficient sequential processing. The entire operation is pipelined architecture designed for high-speed computation. In the example of FIG. 7, the layer normalizer unit 700 may execute layer normalization through 36 cycles. t₀ through t₄ may represent 16 clock cycles.

FIGS. 8A-8C illustrate a GELU unit 800, in accordance with various embodiments. The GELU unit 800 may execute one or more GELU activation functions in a contextual embedding model during inference of the contextual embedding model. The GELU unit 800 may be an example of the GELU unit 460 in FIG. 4. FIG. 8A shows an architecture of the GELU unit 800. FIG. 8B shows outputs of the GELU unit 800 under different conditions. LUT in FIG. 8B stands for look-up table. FIG. 8C shows a curve representing the GELU activation function executed by the GELU unit 800.

As shown in FIG. 8A, the GELU unit 800 includes a look-up table 810, a control unit 820, and a MUX 830. In other embodiments, the GELU unit 800 may include fewer, more, or different components. The look-up table 810 may store precomputed data, such as data computed before inference of the contextual embedding model starts. The look-up table 810 may be configured with the precomputed data before inference of the contextual embedding model starts. The precomputed data may include data computed using at least part of the GELU activation function. The efficiency of the GELU activator can be improved as the result is read from the look-up table 810 instead of being calculated in real time. An input 801 is provided to the look-up table 810, control unit 820, and MUX 830. In some embodiments, the look-up table 810 may have 49,152 lines and can output 16-bit values. The output values may be results of the GELU activation function, which may be denoted as g(x)=0.5x[1+erf(x/\sqrt{2})], where x is the input 801. The control unit 820 may receive most significant bits (MSBs), such as 3-bit MSB, of the input 801. The output of the control unit 820 may be a 2-bit control signal. The MUX 830 may receive three signals: the output of the look-up table 810, the input 801, and zero. The MUX 830 may select one of the three signals based on the control signal from the control unit 820. In an example, the MUX 830 selects the input 801 as its output when sign of the input 801 is zero and MSB is 11. In another example, the MUX 830 selects zero as its output when sign is 1 and MSB is 11. In yet another example, the MUX 830 selects the output of the look-up table 810 as its output for other situations. The output of the MUX 830 may be the result of the GELU activation function.

FIG. 9 illustrates a SoftMax unit 900, in accordance with various embodiments. The SoftMax unit 900 may be a hardware implementation of one or more SoftMax activators (e.g., the SoftMax activator 240 in FIG. 2) in a contextual embedding model during inference of the contextual embedding model. The SoftMax unit 900 may be an example of the SoftMax unit 450 in FIG. 4. The SoftMax unit 900 may run a SoftMax function, which may be denoted as:

$$\frac{{e}^{\frac{{x}_{i} - {x}_{m ax}}{\sqrt{128}}}}{{\sum }_{j = 0}^{t} {e}^{\frac{{x}_{j} - {x}_{m ax}}{\sqrt{128}}}}$$

The SoftMax unit 900 includes look-up table implementation of the SoftMax function instead of a compute-oriented solution. In some embodiments, the SoftMax unit 900 receives an input vector of t FP16 elements (1<t<512) and returns the SoftMax normalized vector of the same size. The SoftMax unit 900 receives 16 numbers per cycle for up to 32 cycles and returns 16 numbers per cycle for up to 32 cycles. In an example, the SoftMax unit 900 receives an input vector including 16 elements, each of which is a FP16 values, in a clock cycle. The total number of bits of the input vector is 256. The SoftMax unit 900 may also receive a compare control signal, normalize control signal, exponent control signal, multiply control signal, on/off control signal, other types of control signals, or some combination thereof. A control signal may have 1 bit. The output of the SoftMax unit 900 may be 16 elements with UFP16 format. The total number bits may be 240. The SoftMax unit 900 may execute the SoftMax function using 16 clock cycles. Numbers may be stored in a FIFO buffer (e.g., FIFO #16 in FIG. 9) while they are compared to find the largest number in the vector. The FIFO buffer may output numbers. The largest number may be subtracted. The subtraction result is provide to a look-up table (LUT #16 for example). The output of the look-up table enters a second FIFO (e.g., the FIFO #32 in FIG. 9). Numbers may be pulled out of the second FIFO and multiplied by the normalization value. It may take a total of 24 cycles to compute the output. The 24 cycles may include 8 latency cycles and 16 piping cycles.

In some embodiments, the SoftMax unit 900 may be included in attention dot unit to perform SoftMax on an input vector (e.g., FP16 vector) and to output a SoftMax-ed vector (e.g., FP16 vector). The SoftMax unit 900 may include ROM 902 storing the look-up table comprising one or more precomputed values of an exponent function:

$$f ( x ) = {e}^{\frac{x}{\sqrt{128}}} .$$

The SoftMax unit 900 may include another ROM 904 storing the look-up table comprising one or more precomputed values of a reciprocal function:

$$f ( x ) = \frac{1}{x} .$$

The SoftMax unit 900 may include tree adder 906 to add a number of values (e.g., 18 values) together simultaneously. The architecture of the SoftMax unit 900 shown in FIG. 9 is an example. The SoftMax unit 900 may have fewer, more, or different components in other embodiments.

FIG. 10 illustrates an embedding dot unit 1000, in accordance with various embodiments. The embedding dot unit 1000 may execute one or more MaxMut operations and add operations in a contextual embedding model during inference of the contextual embedding model. The embedding dot unit 1000 may be an example of the embedding dot unit 440 in FIG. 4.

As shown in FIG. 10, the embedding dot unit 1000 includes a multiplier unit 1010, an adder unit 1020, and a sampler 1030. In other embodiments, the embedding dot unit 1000 may include fewer, more, or different components. The multiplier unit 1010 may perform elements dot product operation between an embedding vector (e.g., FP8 embedding vector) and a weights vector (e.g., FP6 weights vector read from sequential read-only memory) every cycle. The multiplier unit 1010 includes a plurality of weights multipliers. In an example of FIG. 10, the embedding dot unit 1000 may include 4,096 weights multipliers: weights multiplier #1 through weights multiplier #4,096. The weights multipliers may perform multiplication in parallel. The outputs (e.g., 4096 outputs) may be added together by the adder unit 1020.

In the example of FIG. 10, the adder unit 1020 includes 4,095 adders. These adders are arranged in a tree or hierarchical structures. In some embodiments, the adder unit 1020 may use a special fixed-point adder with a relatively large number of bits (e.g., 20 bits, 21 bits, . . . 32 bits). The 4,095 adders may be arranged in 10 tiers. A tier is a level in the tree structure. The first tier includes 2,048 adders, for instance. Each adder in the first tier sums two products from two weights multipliers, respectively. Each adder in the second tier sums the outputs of two adders in the first tier. Each adder in the third tier sums the outputs of two adders in the second tier. This continues till adder #4095 is reached. The adder in the 10^{th} tier outputs the final sum, which may be a 33-bit number, which is then provided to the sampler 1030. The sampler 1030 may be a FP16 sampler. The sampler 1030 may resample the final sum into a floating-point representation. The embedding dot unit 1000 may generate an FP16 output. Using a large number of bits in the adder unit 1020 can prevent overflow during many stages/layers of adding.

FIG. 11 illustrates a sequential read-only memory 1100, in accordance with various embodiments. Sequence read-only memory is a type of memory storage, utilizing ROMs, that allows data to be read sequentially but not written or modified after the values have been etched onto the ROM. The rest of the ROM can be shut down to reduce power and area. In some embodiments, the sequential read-only memory 1100 may be a memory in an IC device implementing a DNN, such as the IC device 400 in FIG. 4. The IC device may include multiple sequential read-only memories. The sequential read-only memory 1100 may be an example of the memories 443 in FIG. 4.

For the purpose of illustration, the sequential read-only memory 1100 in FIG. 11 has six word lines. The sequential read-only memory 1100 can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential read-only memory 1100 can power down the rest of the word lines, or the rest of the word lines in the sequential read-only memory 1100 can remain powered down. At the next clock or time slot, the active current word line is powered down, the active next word line is already powered up, and a further active next word line is powered up. At every clock or time slot, two word lines may be powered up in the sequential read-only memory 1100. Active Word lines may get moved by one word line down the sequential read-only memory at every clock or time slot.

In some embodiments, one or more sequential read-only memories may be provided on the chip to store various weight matrices for a transformer model:

| Num. Lines | Layer | Matrix |
|---|---|---|
| 16 | 0 | W_{Q} |
| 4 | 0 | W_{K} |
| 4 | 0 | W_{V} |
| 16 | 0 | W₀ |
| 112 | 0 | W₁ |
| 56 | 0 | W₂ |
| . . . | . . . | . . . |
| 16 | 31 | W_{Q} |
| 4 | 31 | W_{K} |
| 4 | 31 | W_{V} |
| 16 | 31 | W₀ |
| 112 | 31 | W₁ |
| 56 | 31 | W₂ |
| 16 | 31 | W_{Q} |
| 501 | — | W_{cls} |

In some embodiments, an IC device implementing a DNN may have 1,048,576 ROMs (e.g., sequential read-only memories) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258, and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and layer normalizer unit.

FIGS. 12A-12C illustrate a tanh unit 1200, in accordance with various embodiments.

The tanh unit 1200 may execute one or more tanh activation functions in a contextual embedding model during inference of the contextual embedding model. The tanh unit 1200 may be an example of the tanh unit 470 in FIG. 4. FIG. 12A shows an architecture of the tanh unit 1200. FIG. 12B shows outputs of the tanh unit 1200 under different conditions. LUT in FIG. 12B stands for look-up table. FIG. 12C shows a curve representing the tanh activation function executed by the tanh unit 1200.

As shown in FIG. 12A, the tanh unit 1200 includes a look-up table 1210, a control unit 1220, and a MUX 1230. In other embodiments, the tanh unit 1200 may include fewer, more, or different components. The look-up table 1210 may store precomputed data, such as data computed before inference of the contextual embedding model starts. The precomputed data may be precomputed outputs of a tanh function for various input values. The look-up table 1210 may be configured with the precomputed data before inference of the contextual embedding model starts. The precomputed data may include data computed using at least part of the tanh activation function. The efficiency of the tanh activator can be improved as the result is read from the look-up table 1210 instead of being calculated in real time. An input 1201 is provided to the look-up table 1210, control unit 1220, and MUX 1230. In some embodiments, the look-up table 1210 may have 49,152 lines and can output 16-bit values. The output values may be results of the tanh activation function, which may be denoted as The tanh activation function may be denoted as

$$f ( x ) = \frac{{e}^{x} - {e}^{- x}}{{e}^{x} + {e}^{- x}} ,$$

where x is the input 1201 and f(x) is the output 1202. The control unit 1220 may receive MSBs, such as 3-bit MSB, of the input 1201. The output of the control unit 1220 may be a 2-bit control signal. The MUX 1230 may receive three signals: the output of the look-up table 1210, the input 1201, and zero. The MUX 1230 may select one of the three signals based on the control signal from the control unit 1220. In an example, the MUX 1230 selects the input 1201 as its output when sign of the input 1201 is zero and MSB is 11. In another example, the MUX 1230 selects zero as its output when sign is 1 and MSB is 11. In yet another example, the MUX 1230 selects the output of the look-up table 1210 as its output for other situations. The output of the MUX 1230 may be the result of the tanh activation function.

Certain aspects of hardware implementing models on silicon are further described in U.S. patent application Ser. No. 19/281,006, filed on Jul. 25, 2025, U.S. patent application Ser. No. 19/275,640, filed on Jul. 21, 2025, and U.S. patent application Ser. No. 19/244,318, filed on Jun. 20, 2025, each of which is hereby incorporated by reference in its entirety for all purposes.

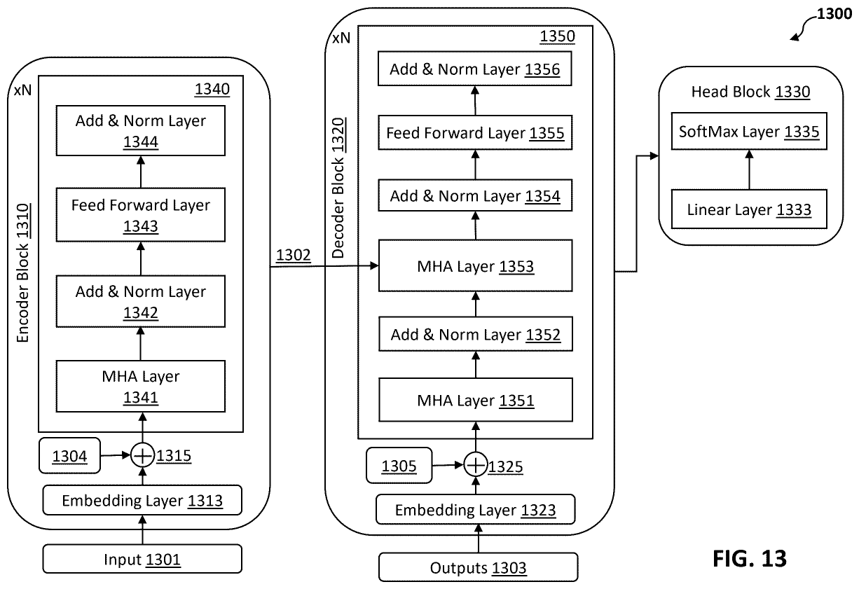

FIG. 13 illustrates an exemplary transformer model 1300, in accordance with various embodiments. The transformer model 1300 may transform input sequences into output sequences. In some embodiments, the transformer model 1300 is a DNN that can learn context and meaning by tracking relationships in sequential data, such as sequential words in a sentence, sequential audio signals, sequential images, and so on. In an example, at least part of the transformer model 1300 may be a contextual embedding model, such as the contextual embedding models described above. As shown in FIG. 13, the transformer model 1300 includes an encoder block 1310, a decoder block 1320, and a head block 1330. In other embodiment, different or additional components may be included in the transformer model 1300. Further, functionality attributed to a component of the transformer model 1300 may be accomplished by a different component included in the transformer model 1300 or a different model or module.

The encoder block 1310 receives input sequences and generates matrix representations of the input sequences. In the embodiments of FIG. 13, the encoder block 1310 receives an input 1301 and generates an encoder output 1302. The input 1301 may be an input prompt. In some embodiments, the input 1301 may include one or more input tokens, such as words, phrases, sentences, images, audio signals, other types of input tokens, or some combination thereof. In an example, the input 1301 may include a prompt received from a user of the transformer model 1300. The prompt may include a question or request made by the user. A word in the prompt may be an input token. The encoder output 1302 may include one or more vectors that are contextualized representations of the input 1301. Each vector in the encoder output 1302 may represent a token in the input 1301 with contextual understanding.

The encoder block 1310 includes an embedding layer 1313, a positional encoding layer 1315, and a plurality of layers 1340 (individually referred to as “layer 1340”). In other embodiments, the encoder block 1310 may have different, fewer, or more components. Also, the arrangement of the components in the encoder block 1310 may be different from the arrangement shown in FIG. 13. For the purpose of illustration, the encoder block 1310 has N layers in FIG. 13, where N is an integer. Each layer 1340 may include one or more neural network operations. The layers 1340 may transform a sequence of embeddings into a representation that encapsulates the learned information from the input 1301. Different layers 1340 may have different internal parameters, e.g., different weights, bias, or other types of internal parameters. In some embodiments, the layers 1340 have identical components. The components in a layer 1340 may be layers and may also be referred to as sub-layers of the layer 1340. As shown in FIG. 13, a layer 1340 includes four sub-layers: a multi-head attention (MHA) layer 1341, an add & norm layer 1342, a feed forward layer 1343, and another add & norm layer 1344.

The decoder block 1320 iteratively generates outputs 1303 using encoded representations generated by the encoder block 1310. The decoder block 1320 includes an embedding layer 1323, a positional encoding layer 1325, and a plurality of layers 1350 (individually referred to as “layer 1350”). For the purpose of illustration, the decoder block 1320 has N layers in FIG. 13, where N is an integer. In the embodiments of FIG. 13, the number of layers 1350 in the decoder block 1320 is the same as the number of layers 1340 in the encoder block 1310. In other embodiments, the number of layers 1350 in the decoder block 1320 may be different from the number of layers 1340 in the encoder block 1310. Each layer 1350 may include one or more neural network operations. Different layers 1350 may have different internal parameters. In some embodiments, the layers 1350 may have identical components. The components in a layer 1350 may be layers and may also be referred to as sub-layers of the layer 1350. As shown in FIG. 13, a layer 1350 includes six sub-layers: an MHA layer 1351, an add & norm layer 1352, another MHA layer 1353, another add & norm layer 1354, a feed forward layer 1355, and another add & norm layer 1356.

In some embodiments, a sequence of inference stages is performed in the decoder block 1320 using encoder outputs, e.g., the encoder output 1302. A matrix may be predicted through each inference stage. The outputs 1303 may include a plurality of matrices. Each matrix may be further processed in the head block 1330 to predict a token. The plurality of matrices may be used to predict a sequence of tokens. For the first inference stage, the decoder block 1320 may receive one or more start tokens as input tokens and compute a first matrix from the input tokens and the output of the encoder block 1310. The first matrix may be used by the head block 1330 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 1330 receives the output of the decoder block 1320 and processes it in a linear layer 1333 and a SoftMax layer 1335. A linear operation may be performed on the output of the decoder block 1320 in the linear layer 1333. The linear operation may include a multiplication of the output of the decoder block 1320 with a weight matrix. The output of the linear layer 1333 may be a vector. In some embodiments, the head block 1330 may function as a classifier. The number of data elements in the vector computed in the linear layer 1333 may depend on the number of classes involved. In an example where there are M classes, where M is an integer, the vector computed in the linear layer 1333 may have M data elements representing the prediction for the M classes, respectively.

The output of the linear layer 1333 may be input into the SoftMax layer 1335. A SoftMax function may be applied on the output of the linear layer 1333 to compute probability scores. A probability score may have a value in the range from 0 to 13. In some embodiments, a probability value is computed for each data element in the vector computed in the linear layer 1333. The highest one of the probability scores may be the key. The corresponding index of the key may point to the token that the transformer model 1300 predicts as the next in the sequence. The final output of the transformer model 1300 may be the sequence of predicted tokens. In some embodiments, the head block 1330 may be a language modeling head.

An embedding layer (e.g., the embedding layer 1313 or the embedding layer 1323) converts an input of the embedding layer (e.g., the input 1301 or the outputs 1303) into one or more embeddings. An embedding may be a vector, which is also referred to as an embedding vector or a vector embedding. The vector embedding may include a sequence of data elements. In some embodiments, the embedding layer 1313 may generate a plurality of embeddings, each of which may be converted from a different input token in the input 1301. The embeddings may capture the semantic meaning of the tokens in the input 1301. The embeddings may be numerical representations that capture the relationships or meanings of words, phrases, or other data types. In an example where the input 1301 is a prompt including a sequence of words, the embedding layer 1313 may generate an embedding from each word in the input 1301. The embedding layer 1323 in the decoder block 1320 may generate a plurality of embeddings from tokens received by the decoder block 1320 in a similar manner as the embedding layer 1313.

A positional encoding layer (e.g., the positional encoding layer 1315 or the positional encoding layer 1325) performs positional encoding on embeddings generated in the corresponding embedding layer. In some embodiments, the positional encoding layer may apply one or more positional encoding vectors (e.g., a positional encoding vector 1304 or positional encoding vector 1305) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 1341, the MHA layer 1351, or the MHA layer 1353) may implement a multi-head attention mechanism, which may be a multi-head self-attention mechanism or a multi-head cross-attention mechanism. In some embodiments, the MHA layer 1341 or the MHA layer 1351 may implement a self-attention mechanism. For self-attention, the queries, keys, and values may come from the same place. For instance, for the MHA layer 1341, the queries, keys, and values may all come from the positional encoding layer 1315. For the MHA layer 1351, the queries, keys, and values may all come from the positional encoding layer 1325. The self-attention mechanism may enable the transformer model 1300 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 1341 may be computed from vector embeddings generated by the positional encoding layer 1315. The queries, keys, and values input into the MHA layer 1351 may be computed from vector embeddings generated by the positional encoding layer 1325. A query, key, or value may be a vector the represents a token in a sequence. In some embodiments, a query matrix Q∈ [symbol] ^{N×h} may be computed by multiply an embedding matrix X∈ [symbol] ^{N×d} (e.g., an embedding matrix computed in a positional encoding layer) with a weight matrix W_{q}∈ [symbol] ^{d×h}, where d is the dimension of a vector embedding, N is the number of vector embeddings in the embedding matrix, and h is the number of attention heads. Each row in the query matrix may be a query. A key matrix K∈ [symbol] ^{N×h} may be computed by multiple an embedding matrix X∈ [symbol] ^{N×d} (e.g., an embedding matrix computed in a positional encoding layer) with a weight matrix Wₖ∈ [symbol] ^{d×h}. Each row in the key matrix may be a key. A value matrix V∈ [symbol] ^{N×h} may be computed by multiple an embedding matrix X∈ [symbol] ^{N×d} (e.g., an embedding matrix computed in a positional encoding layer) with a weight matrix Wᵥ∈ [symbol] ^{d×h}. Each row in the value matrix may be a value.

In some embodiments, the MHA layer 1351 may implement masked multi-head self-attention. The MHA layer 1351 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 1353 may implement a cross-attention mechanism, such as encoder-decoder cross-attention. The MHA layer 1353 may use outputs from the previous layer (i.e., the add & norm layer 1352) as queries and use outputs from the encoder block 1310 as keys and values. The cross-attention can align the encoder's input with the decoder's, empowering the decoder block 1320 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as QWᵢ^{Q}, where Q is the query matrix and Wᵢ^{Q}∈ [symbol] ^{d}^{_{model}}^{×d}^{_{q}} is the weight matrix. A second linear layer may perform a multiplication of the key matrix with a weight matrix to compute a second parameter matrix. The second parameter matrix may be denoted as KWᵢ^{K}, where K is the key matrix and Wᵢ^{K}∈ [symbol] ^{d}^{_{model}}^{×d}^{ₖ} is the weight matrix. A third linear layer may perform a multiplication of the value matrix with a weight matrix to compute a third parameter matrix. The third parameter matrix may be denoted as VWᵢ^{V}, where V is the value matrix and Wᵢ^{V}∈ [symbol] ^{d}^{_{model}}^{×d}^{ₖ} is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as headᵢ=Attention (QWᵢ^{Q}, KWᵢ^{K}, VWᵢ^{V}).

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A SoftMax function may be applied on the scaled matrix in the SoftMax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead (Q, K, V)=Concat (head₁, head₂, . . . , headₕ)W^{O}, where Concat denotes concatenation, and W^{O}∈ [symbol] ^{hd}^{ᵥ}^{×d}^{_{model}} is the weight matrix in the corresponding linear layer.

An add & norm layer in the transformer model 1300, such as the add & norm layer 1342, 1344, 1352, 1354, and 1356, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 1342 is the MHA layer 1341. As another example, the preceding layer of the add & norm layer 1354 is the MHA layer 1353.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{xy} = \frac{1}{Z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{xy}^{2} = {\sum }_{z = 1}^{Z} {D}_{xyz}^{2}$$

and a division computation denoted as

$${M}_{xy} = \frac{1}{\sqrt{\frac{1}{Z} \times ( {σ}_{xy}^{2} + ϵ \times Z )}} .$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$$\begin{matrix}{A}_{xyz}^{′} = \frac{{A}_{xyz} - {μ}_{xyz}}{\sqrt{\frac{1}{Z} \times ( {σ}_{xy}^{2} + ϵ )}} \\ = ( {A}_{xyz} - {μ}_{xyz} ) \times \frac{1}{\sqrt{\frac{1}{Z} \times ( {σ}_{xy}^{2} + ϵ )}} \\ = {D}_{xyz} \times {M}_{xyz} .\end{matrix}$$

The layer normalization operation may further compute

$${A}_{xyz}^{″} = {A}_{xyz}^{′} + \frac{{β}_{Z}}{{γ}_{Z}} and L {N}_{xyz} = {A}_{xyz}^{″} \times {γ}_{Z} \cdot L {N}_{xyz}$$

may be the output of the layer normalization operation.

A feed forward layer (e.g., the feed forward layer 1343 and the feed forward layer 1355) may be a position-wise fully-connected feed forward network. In an example, the feed forward layer may include two linear layers with an activation function in between. An example of the activation function is Rectified Linear Unit (ReLU).

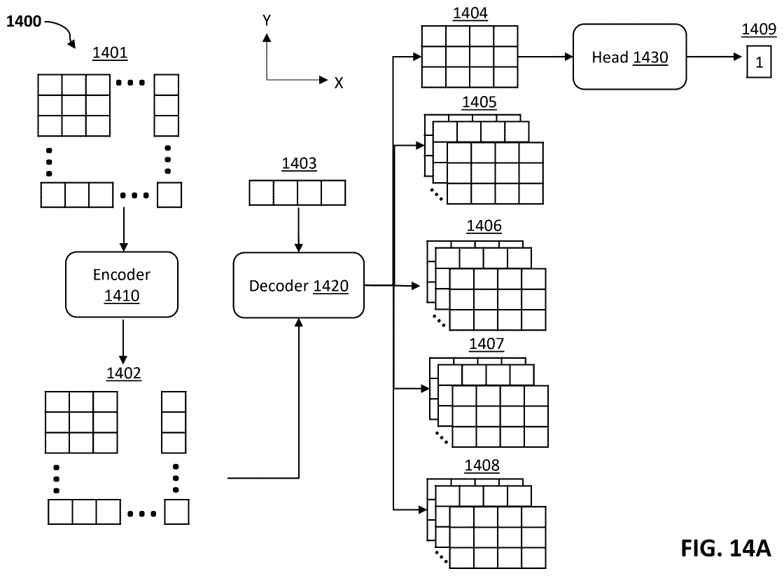

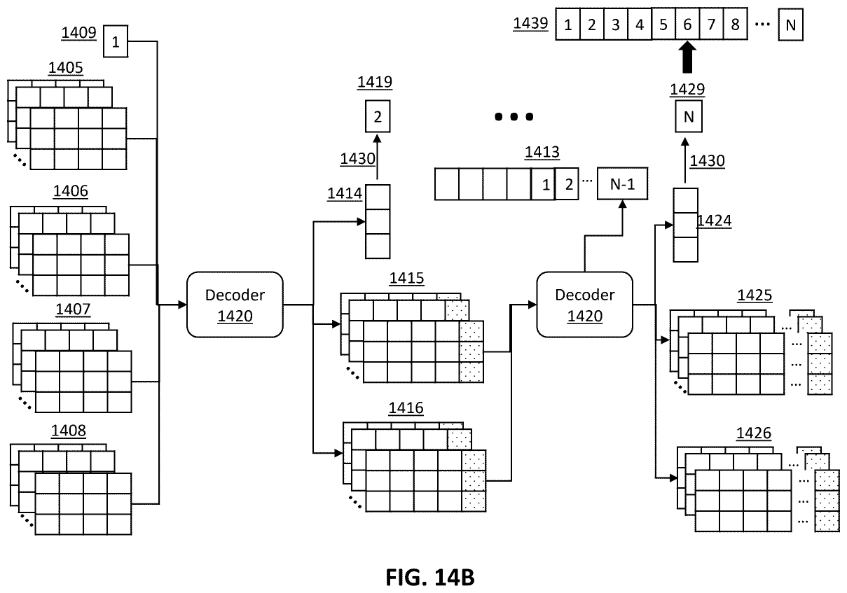

FIG. 14A illustrates a first inference phase of a transformer model 1400, in accordance with various embodiments. The transformer model 1400 includes an encoder 1410, a decoder 1420, and a head 1430. An example of the transformer model 1400 may be the transformer model 1300 in FIG. 13. In the embodiments of FIG. 14A, the encoder 1410 receives an input tensor 1401. The input tensor 1401 may be a feature map extracted from one or more images, text documents, audio files, videos, other types of data, or some combination thereof. The encoder 1410 generates an output tensor 1402 from the input tensor 1401. The shape of the output tensor 1402 may be denoted as [batch size, SL_{encoder}, d_{model}], where SL_{encoder}may be the dimension along the X axis (i.e., the width of the output tensor 1402), and d_{model} may be the dimension along the Y axis (i.e., the height of the output tensor 1402). The encoder 1410 may include a plurality of layers arranged in a sequence, such as the layers inside the encoder block 1310 in FIG. 13. The output tensor 1402 is provided to the decoder 1420.

The decoder 1420 receives the output tensor 1402 and an input sequence 1403. The input sequence 1403 may be a sequence of tokens. A token may be a numerical representation of an input signal, such as word, image, audio signal, video signal, etc. The dimension of the input sequence 1403, which may be denoted as SLᵢₙₚᵤₜ, may be the total number of tokens in the input sequence 1403. For the purpose of illustration and simplicity, SLᵢₙₚᵤₜ is 4. In other embodiments, the input sequence 1403 may have a different shape. For instance, the input sequence 1403 may be a 2D tensor. The dimension of the 2D tensor along the X axis may be SLᵢₙₚᵤₜ, while the dimension of the 2D tensor along the Y axis may be a batch size indicating the number of batches in the input sequence 1403.

The decoder 1420 computes an output tensor 1404, a self-attention key tensor 1405, a self-attention value tensor 1406, a cross-attention key tensor 1407, and a cross-attention value tensor 1408. In some embodiments, the shape of the output tensor 1404 may be denoted as [batch size, SLᵢₙₚᵤₜ, d_{model}]. The shape of the self-attention key tensor 1405 or the shape of the self-attention value tensor 1406 may be denoted as N×[batch size, h, SLᵢₙₚᵤₜ, d_{head}], where N is the number of identical layers in the decoder (e.g., the number of layers 1350 in the decoder block 1320), h is the total number of heads in a MHA layer, and d_{head} is the dimension of a query vector, key vector, or value vector. In some embodiments, d_{model}=h×d_{head}. The shape of the cross-attention key tensor 1407 or the shape of the cross-attention value tensor 1408 may be denoted as N×[batch size, h, SL_{encoder}, d_{head}].

The output tensor 1404 may be provided to the head 1430 and the head 1430 outputs a predicted token 1409. The shape of the token 1409 may be denoted as [batch size, 1]. For the purpose of illustration and simplicity, batch size is 1 in FIG. 14A. In other embodiments, batch size may be a larger number. The predicted token 1409 may be stored in a buffer. In some embodiments, the predicted token 1409 may be used to update the input sequence 1403. For instance, the predicted token 1409 may be added to the right of the input sequence 1403. The updated input sequence may be used as the input sequence in the second inference phase. In the second inference phase, the decoder 1420 may receive the updated input sequence and the output tensor 1402 for predicting another token. The output tensor 1402 may remain the same during inference of the decoder 1420. Certain aspects of subsequent inference phases are described below in conjunction with FIG. 14B.

In some embodiments, the self-attention key tensor 1405 and the self-attention value tensor 1406 may be provided to a self-attention layer in the decoder 1420, an example of such a self-attention layer is the MHA layer 151. The self-attention key tensor 1405 may be stored in a self-attention key cache. The self-attention key cache may have the same shape as the self-attention key tensor 1405. The self-attention value tensor 1406 may be stored in a self-attention value cache. The self-attention value cache may have the same shape as the self-attention value tensor 1406.

In some embodiments, the decoder 1420 computes the self-attention key tensor 1405 and the self-attention value tensor 1406 from the input sequence 1403. The input sequence 1403 may be dynamic during inference of the decoder 1420. For instance, a new token may be added to the input sequence 1403 after each inference phase, as described above. As the input sequence 1403 changes, the self-attention key tensor 1405 and the self-attention value tensor 1406 would also change. For instance, the dimension of the self-attention key tensor 1405 or the self-attention value tensor 1406 along the X axis may increase as SLᵢₙₚᵤₜ increases. The self-attention key cache and the self-attention value cache may change during all the inference phases of the decoder 1420 to accommodate the changes in the self-attention key tensor 1405 and the self-attention value tensor 1406.

In some embodiments, the cross-attention key tensor 1407 and the cross-attention value tensor 1406 may be provided to a cross-attention layer in the decoder 1420, an example of such a cross-attention layer is the MHA layer 153. The cross-attention key tensor 1407 may be stored in a cross-attention key cache. The cross-attention key cache may have the same shape as the cross-attention key tensor 1407. The cross-attention value tensor 1408 may be stored in a cross-attention value cache. The cross-attention value cache may have the same shape as the cross-attention value tensor 1408. In some embodiments, the decoder 1420 computes the cross-attention key tensor 1407 and the cross-attention value tensor 1406 from the output tensor 1402 generated in the encoder 1410. As the output tensor 1402 does not change during inference of the decoder 1420, the cross-attention key tensor 1407 and the cross-attention value tensor 1406 may remain the same during all the inference phases of the decoder 1420. The cross-attention key cache and the cross-attention value cache may remain the same during all the inference phases of the decoder 1420.

FIG. 14B illustrates subsequent inference phases of the transformer model, in accordance with various embodiments. In the second inference phase, the decoder 1420 may reuse the self-attention key tensor 1405, self-attention value tensor 1406, cross-attention key tensor 1407, and cross-attention value tensor 1408. The decoder 1420 also receives the predicted token 1409. The decoder 1420 may compute self-attention key vectors from the predicted token 1409 and concatenate the self-attention key vectors with the self-attention key tensor 1405 to generate a new self-attention key tensor 1415. For instance, a self-attention key vector for each head may be added to the right of a self-attention key matrix in the self-attention key tensor 1405, and the self-attention key vector and the self-attention key matrix may correspond to the same head. The elements highlighted with a dot pattern in the self-attention key tensor 1415 are the self-attention key vectors generated from the predicted token 1409.

Similarly, the decoder 1420 may compute self-attention value vectors from the predicted token 1409 and concatenate the self-attention value vectors with the self-attention value tensor 1406 to generate a new self-attention value tensor 1416. For instance, a self-attention value vector for each head may be added to the right of a self-attention value matrix in the self-attention value tensor 1406, and the self-attention value vector and the self-attention value matrix may correspond to the same head. The elements highlighted with a dot pattern in the self-attention value tensor 1416 are the self-attention value vectors generated from the predicted token 1409.

The decoder 1420 also generates an output tensor 1414. The decoder 1420 may generate the output tensor 1414 using the new self-attention key tensor 1415 and new self-attention value tensor 1416. The output tensor 1414 is used by the head 1430 to generate another predicted token 1419. The predicted token 1419 is the output of the transformer model 1400 in the second inference phase.

One or more other subsequent inference phases may be conducted. In each subsequent inference phase, the decoder 1420 receives a token predicted in the previous inference phase, a self-attention key tensor generated in the previous inference phase, a self-attention value tensor generated in the previous inference phase, the cross-attention key tensor 1407, and the cross-attention value tensor 1408. The decoder 1420 may, in the subsequent inference phase, generate a larger self-attention key tensor and a larger self-attention value tensor, in addition to an output tensor which can be used by the head 1430 to predict a new token.

In embodiments where the total number of inference phases is N, the input sequence 1403 is updated to an input sequence 1413 after N-1 inference phases. In the last inference phase (i.e., the Nth inference phase), the decoder 1420 may receive the predicted token generated in the (N-1)th inference phase, the self-attention key tensor generated in the (N-1)th inference phase, the self-attention value tensor generated in the (N-1)th inference phase, the cross-attention key tensor 1407, and the cross-attention value tensor 1408. The decoder 1420 may generate a self-attention key tensor 1425 and a self-attention value tensor 1426 using the predicted token generated in the (N-1)th inference phase, the self-attention key tensor generated in the (N-1)th inference phase, and the self-attention value tensor generated in the (N-1)th inference phase. The dimensions of the self-attention key tensor 1425 or self-attention value tensor 1426 along the X axis is SLᵢₙₚᵤₜ+N. The decoder 1420 also generates an output tensor 1424, which is used by the head 1430 to generate the last predicted token 1429. The N tokens predicted by the transformer model in the N inference phases may constitute an output tensor 1439, which may be the final output of the transformer model.

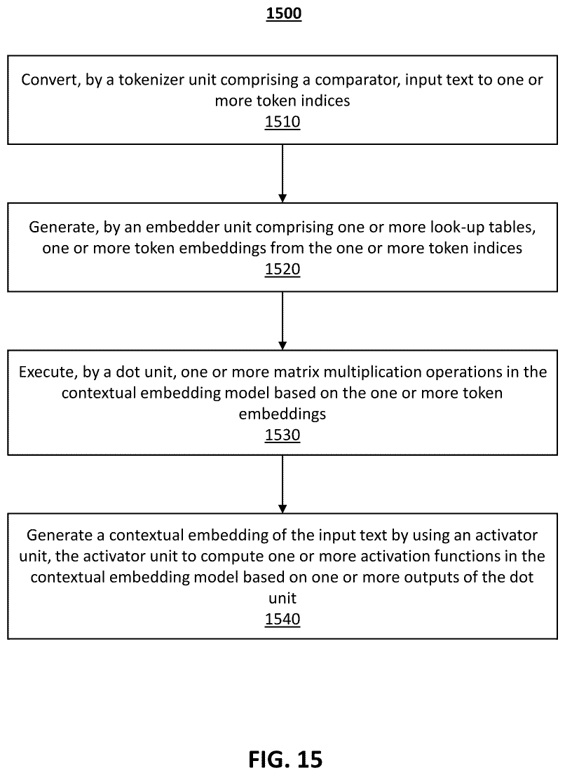

FIG. 15 is a flowchart of a method 1500 of executing a contextual embedding model, in accordance with various embodiments. The method 1500 may be performed by the IC device 400 in FIG. 4. Although the method 1500 is described with reference to the flowchart illustrated in FIG. 15, many other methods for executing contextual embedding models may alternatively be used. For example, the order of execution of the steps in FIG. 15 may be changed. As another example, some of the steps may be changed, eliminated, or combined.

The IC device 400 converts 1510, by a tokenizer unit comprising a comparator, input text to one or more token indices. In some embodiments, a token index is a token ID. In some embodiments, the tokenizer unit further comprises a memory that stores a predefined vocabulary of the contextual embedding model. The input text is converted to the one or more token indices based on the predefined vocabulary.

The IC device 400 generates 1520, by an embedder unit comprising one or more look-up tables, one or more token embeddings from the one or more token identifiers. In some embodiments, the embedder unit further comprises data storage units that store positional embeddings and token-type embeddings. In some embodiments, the embedder unit further comprises an adder to generate combined embeddings by accumulating token embeddings with the embeddings stored in the data storage units. The combined embeddings may be the output of the embedder unit.

The IC device 400 executes 1530, by a dot unit, one or more matrix multiplication operations in the contextual embedding model based on the one or more token embeddings. In some embodiments, executing the one or more matrix multiplication operations includes storing weights of the one or more matrix multiplication operations in a ROM. In some embodiments, the ROM is a sequential read-only memory. In some embodiments, the one or more matrix multiplication operators comprises a matrix multiplication operator in an encoder of the contextual embedding model and a matrix multiplication operator in a pooler of the contextual embedding model. In some embodiments, the IC device 400 further executes, by the dot unit, one or more add operations in the contextual embedding model.

The IC device 400 generates 1540 a contextual embedding of the input text by using an activator unit. The activator unit is to compute one or more activation functions in the contextual embedding model based on one or more outputs of the dot unit. In some embodiments, the one or more activation functions include a tanh function. In some embodiments, the IC device 400 further orchestrates by a flow control unit, the tokenizer unit, embedder unit, dot unit, and activator unit in accordance with a timing sequence of neural network operations in the contextual embedding model.

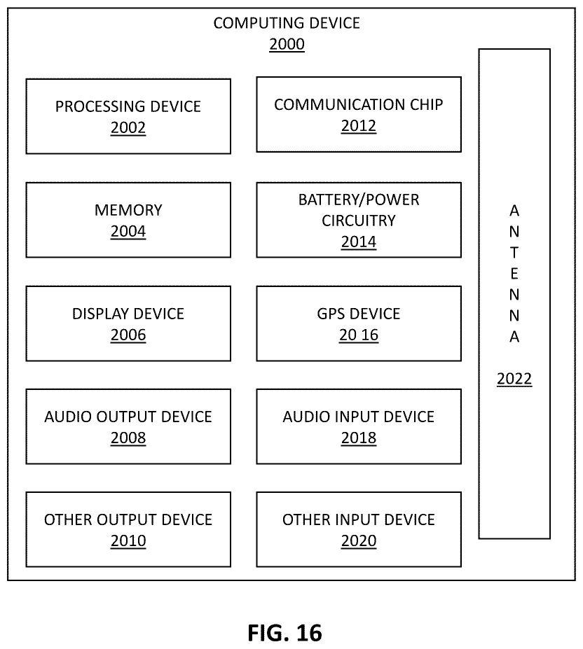

FIG. 16 is a block diagram of an example computing device 2000, in accordance with various embodiments. A number of components are illustrated in FIG. 16 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single SoC die. Additionally, in various embodiments, the computing device 2000 may not include one or more of the components illustrated in FIG. 16, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The processing device 2002 may include one or more IC devices implementing contextual embedding models, such as the IC device 400 in FIG. 4. The computing device 2000 may include a memory 2004, which may itself include one or more memory devices such as volatile memory (e.g., DRAM), nonvolatile memory (e.g., ROM), high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations, such as operations of the IC device 400 in FIG. 4 or methods of executing contextual embedding models (e.g., the method 1500 in FIG. 15). The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides an IC device for implementing a contextual embedding model, including a tokenizer unit to receive input text and to output one or more token indices of the input text; an embedder unit to generate one or more token embeddings using the one or more token indices; and a dot unit to perform one or more matrix multiplication operations based on the one or more token embeddings.

Example 2 provides the IC device of example 1, in which the tokenizer unit includes a comparator, the comparator to compare the input text with one or more vocabularies of the contextual embedding model.

Example 3 provides the IC device of example 2, in which the tokenizer unit further includes a read-only memory, the read-only memory to store the one or more vocabularies of the contextual embedding model.

Example 4 provides the IC device of any one of examples 1-3, in which the embedder unit includes one or more look-up tables, the one or more look-up tables to store a plurality of token embeddings.

Example 5 provides the IC device of example 4, in which the embedder unit further includes one or more data storage units and an adder, the one or more data storage units to store one or more other embeddings, the adder to generate the one or more token embeddings by combining one or more of the plurality of token embeddings from the one or more look-up tables with one or more other embeddings.

Example 6 provides the IC device of any one of examples 1-5, in which the dot unit includes one or more multipliers and one or more adders.

Example 7 provides the IC device of example 6, in which the dot unit further includes one or more sequential read-only memories, the one or more sequential read-only memories to store weights of the one or more matrix multiplication operators.

Example 8 provides the IC device of any one of examples 1-7, in which the one or more matrix multiplication operators includes a matrix multiplication operator in an encoder of the contextual embedding model and a matrix multiplication operator in a pooler of the contextual embedding model.

Example 9 provides the IC device of any one of examples 1-8, further including an activator unit to implement an activation function in the contextual embedding model.

Example 10 provides the IC device of example 9, in which the activation function is a tanh function, in which the activator unit includes a look-up table, the look-up table including precomputed outputs of the tanh function.

Example 11 provides a computing system, including a first unit including a comparator, the first unit to receive input text and to output one or more token indices of the input text; a second unit including one or more look-up tables, the second unit to generate one or more token embeddings using the one or more token indices; and a third unit including one or more multipliers and one or more adders, the third unit to perform multiplications and additions based on the one or more token embeddings.

Example 12 provides the computing system of example 11, in which the first unit is to implement a tokenizer in a contextual embedding model, in which the comparator is to compare the input text with one or more vocabularies of the contextual embedding model.

Example 13 provides the computing system of example 12, in which the first unit further includes a read-only memory, the read-only memory to store the one or more vocabularies of the contextual embedding model.

Example 14 provides the computing system of any one of examples 11-13, in which the second unit is to implement one or more embedders in a contextual embedding model, in which the one or more look-up tables are to store a plurality of token embeddings of the contextual embedding model.

Example 15 provides the computing system of example 14, in which the second unit further includes one or more data storage units and an adder, the one or more data storage units to store one or more other embeddings, the adder to generate the one or more token embeddings by combining one or more of the plurality of token embeddings from the one or more look-up tables with one or more other embeddings.

Example 16 provides the computing system of any one of examples 11-15, in which the third unit is to implement one or more matrix multiplication operators in a contextual embedding model.

Example 17 provides the computing system of example 16, in which the third unit further includes one or more sequential read-only memories, the one or more sequential read-only memories to store weights of the one or more matrix multiplication operators.

Example 18 provides the computing system of example 16 or 17, in which the one or more matrix multiplication operators includes a matrix multiplication operator in an encoder of the contextual embedding model and a matrix multiplication operator in a pooler of the contextual embedding model.

Example 19 provides the computing system of any one of examples 11-18, further including a fourth unit including a look-up table, the fourth unit to compute an activation function in a contextual embedding model.

Example 20 provides the computing system of example 19, in which the activation function is a tanh function.

Example 21 provides one or more non-transitory computer-readable media storing instructions executable to perform operations for executing a contextual embedding model, the operations including converting, by a tokenizer unit including a comparator, input text to one or more token indices; generating, by an embedder unit including one or more look-up tables, one or more token embeddings from the one or more token indices; executing, by a dot unit, one or more matrix multiplication operations in the contextual embedding model based on the one or more token embeddings; and generating a contextual embedding of the input text by using an activator unit, the activator unit to compute one or more activation functions in the contextual embedding model based on one or more outputs of the dot unit.

Example 22 provides the one or more non-transitory computer-readable media of example 21, in which the operations further include orchestrating, by a flow control unit, the tokenizer unit, embedder unit, dot unit, and activator unit in accordance with a timing sequence of neural network operations in the contextual embedding model.

Example 23 provides the one or more non-transitory computer-readable media of example 21 or 22, in which the operations further include executing, by the dot unit, one or more add operations in the contextual embedding model.

Example 24 provides the one or more non-transitory computer-readable media of any one of examples 21-23, in which executing the one or more matrix multiplication operations includes storing weights of the one or more matrix multiplication operations in a read-only memory of the dot unit.

Example 25 provides the one or more non-transitory computer-readable media of any one of examples 21-24, in which the one or more activation functions include a tanh function.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An integrated circuit (IC) device for implementing a contextual embedding model, comprising:
a tokenizer unit to receive input text and to output one or more token indices of the input text;
an embedder unit to generate one or more token embeddings using the one or more token indices; and
a dot unit to perform one or more matrix multiplication operations based on the one or more token embeddings.

2. The IC device of claim 1, wherein the tokenizer unit comprises a comparator, the comparator to compare the input text with one or more vocabularies of the contextual embedding model.

3. The IC device of claim 2, wherein the tokenizer unit further comprises a read-only memory, the read-only memory to store the one or more vocabularies of the contextual embedding model.

4. The IC device of claim 1, wherein the embedder unit comprises one or more look-up tables, the one or more look-up tables to store a plurality of token embeddings.

5. The IC device of claim 4, wherein the embedder unit further comprises one or more data storage units and an adder, the one or more data storage units to store one or more other embeddings, the adder to generate the one or more token embeddings by combining one or more of the plurality of token embeddings from the one or more look-up tables with one or more other embeddings.

6. The IC device of claim 1, wherein the dot unit comprises one or more multipliers and one or more adders.

7. The IC device of claim 6, wherein the dot unit further comprises one or more sequential read-only memories, the one or more sequential read-only memories to store weights of the one or more matrix multiplication operators.

8. The IC device of claim 1, wherein the one or more matrix multiplication operators comprises a matrix multiplication operator in an encoder of the contextual embedding model and a matrix multiplication operator in a pooler of the contextual embedding model.

9. The IC device of claim 1, further comprising:
an activator unit to implement an activation function in the contextual embedding model.

10. The IC device of claim 9, wherein the activation function is a tanh function, wherein the activator unit comprises a look-up table, the look-up table including precomputed outputs of the tanh function.

11. A computing system, comprising:
a first unit comprising a comparator, the first unit to receive input text and to output one or more token indices of the input text;
a second unit comprising one or more look-up tables, the second unit to generate one or more token embeddings using the one or more token indices; and
a third unit comprising one or more multipliers and one or more adders, the third unit to perform multiplications and additions based on the one or more token embeddings.

12. The computing system of claim 11, wherein the first unit is to implement a tokenizer in a contextual embedding model, wherein the comparator is to compare the input text with one or more vocabularies of the contextual embedding model.

13. The computing system of claim 12, wherein the first unit further comprises a read-only memory, the read-only memory to store the one or more vocabularies of the contextual embedding model.

14. The computing system of claim 11, wherein the second unit is to implement one or more embedders in a contextual embedding model, wherein the one or more look-up tables are to store a plurality of token embeddings of the contextual embedding model.

15. The computing system of claim 14, wherein the second unit further comprises one or more data storage units and an adder, the one or more data storage units to store one or more other embeddings, the adder to generate the one or more token embeddings by combining one or more of the plurality of token embeddings from the one or more look-up tables with one or more other embeddings.

16. The computing system of claim 11, wherein the third unit is to implement one or more matrix multiplication operators in a contextual embedding model.

17. The computing system of claim 16, wherein the third unit further comprises one or more sequential read-only memories, the one or more sequential read-only memories to store weights of the one or more matrix multiplication operators.

18. The computing system of claim 16, wherein the one or more matrix multiplication operators comprises a matrix multiplication operator in an encoder of the contextual embedding model and a matrix multiplication operator in a pooler of the contextual embedding model.

19. The computing system of claim 11, further comprising:
a fourth unit comprising a look-up table, the fourth unit to compute an activation function in a contextual embedding model.

20. The computing system of claim 19, wherein the activation function is a tanh function.

21. One or more non-transitory computer-readable media storing instructions executable to perform operations for executing a contextual embedding model, the operations comprising:
converting, by a tokenizer unit comprising a comparator, input text to one or more token indices;
generating, by an embedder unit comprising one or more look-up tables, one or more token embeddings from the one or more token indices;
executing, by a dot unit, one or more matrix multiplication operations in the contextual embedding model based on the one or more token embeddings; and
generating a contextual embedding of the input text by using an activator unit, the activator unit to compute one or more activation functions in the contextual embedding model based on one or more outputs of the dot unit.

22. The one or more non-transitory computer-readable media of claim 21, wherein the operations further comprise:
orchestrating, by a flow control unit, the tokenizer unit, embedder unit, dot unit, and activator unit in accordance with a timing sequence of neural network operations in the contextual embedding model.

23. The one or more non-transitory computer-readable media of claim 21, wherein the operations further comprise:
executing, by the dot unit, one or more add operations in the contextual embedding model.

24. The one or more non-transitory computer-readable media of claim 21, wherein executing the one or more matrix multiplication operations comprises storing weights of the one or more matrix multiplication operations in a read-only memory of the dot unit.

25. The one or more non-transitory computer-readable media of claim 21, wherein the one or more activation functions include a tanh function.
